(19) United States
(12) Patent Application Publication
(10) Pub. No.: US 2014/0281761 A1
(43) Pub. Date: Sep. 18, 2014

(54) Reversible corruption of a digital medium stream by multi-valued modification in accordance with an automatically generated mask

(71) Applicant: Peter Lablans, Morris Township, NJ (US)

(72) Inventor: Peter Lablans, Morris Township, NJ (US)

(21) Appl. No.: 14/292,883

(22) Filed: May 31, 2014

Related U.S. Application Data
(63) Continuation-in-part of application No. 12/400,900, filed on Mar. 10, 2009.
(60) Provisional application No. 61/035,563, filed on Mar. 11, 2008.

(51) Int. Cl. G06F 11/10

(52) U.S. Cl. CPC G06F 11/10
USPC 714/701

(57) ABSTRACT

Methods and apparatus create a corruption mask from a sequence that is generated by an n-state sequence generator with n>2. A digital media stream containing n-state symbols is corrupted in accordance with the corruption mask. The corruption takes place by applying a one argument or a two argument n-state logic function. The corruption rate of the digital media stream is preferably less than 100% allowing it to be reviewed. Data related to the corruption mask and the corruption mask are transmitted to a processor based receiver, allowing the receiver to decorrupt the corrupted digital media stream and to display it in its uncorrupted state.

### STATEMENT OF RELATED CASES

This application is a continuation-in-part of U.S. patent application Ser. No. 12/400,900 filed on Mar. 10, 2009, which is incorporated herein by reference in its entirety, and which claims the benefit of U.S. Provisional Patent Application Ser. No. 61/035,563 filed on Mar. 11, 2008, which is incorporated herein by reference in its entirety.

### BACKGROUND OF THE INVENTION

The present invention relates to a modification of a digital media stream containing n-state symbols, with n>2 or n being non-binary, in accordance with a modification or corruption mask. In case the corruption rate is smaller than 100%, a user can display the modified or corrupted digital media stream, but not in its original quality.

Based on reviewing the corrupted digital media stream, which may be a digital image, a digital video, a digital sound stream, a digital document or any digital symbol stream that can be reviewed or played on a review medium, such as a computer screen display, an audio display such as a loudspeaker, print paper or any other display that provides an output or signal that can be reviewed, if necessary after appropriate transformation or conversion, from digital form into reviewable form, a user may decide to obtain, such as purchasing, an uncorrupted media stream.

It is believed that currently no adequate apparatus and methods are available that automatically generate a corruption mask and that allow to reverse or decorrupt the modified digital medium stream into its original, uncorrupted form. In one embodiment a corrupted digital media stream should be realized without increasing or significantly increasing redundancy in the digital medium stream.

Accordingly, novel and improved methods and apparatus providing automatic generation of a corruption mask in a digital medium screen and/or reversing a corrupted digital medium stream are required.

### SUMMARY OF THE INVENTION

In accordance with an aspect of the present invention an apparatus is provided for correcting errors in a sequence of k n-state data symbols, an n-state symbol being represented by a signal, with n>2, and k≧1, comprising, a memory enabled to store instructions, a processor that retrieves and executes instructions from the memory to perform the steps of receiving on an input a plurality of signals representing the sequence of k n-state symbols and p n-state check symbols with p≦k, each of the signals representing p n-state check symbols being generated by an implementation of one of p independent reversible n-state expressions using the k n-state symbols as variables, determining as an independent step which of up to p of the k n-state data symbols are potentially in error and solving as an independent step up to p independent n-state expressions to determine an n-state value for the up to p of the k n-state symbols that are potentially are in error, wherein the solving applies at least an implementation of an n-state reversible logic function that is determined by an n by n truth table.

In accordance with an aspect of the present invention a system is provided to process a digital medium stream containing a plurality of symbols, each symbol being represented by one or more signals, comprising: a source memory enabled to store and provide data including instructions; a source processor configured to retrieve and execute instructions from the source memory to perform the steps: generating a corruption mask determined by a sequence of symbols, generated by a sequence generator; and modifying a plurality of n-state symbols with n>2 in the digital medium stream in accordance with the corruption mask to create a corrupted digital medium stream.

In accordance with a further aspect of the present invention a system is provided, further comprising: the source processor executing instructions to apply a first n-state logic function with n>2 to create a corrupted n-state symbol in the corrupted digital medium stream.

In accordance with yet a further aspect of the present invention a system is provided, further comprising: transmitting the corrupted digital medium stream to a target processor configured to retrieve instructions from a target memory to perform the steps: generating the corruption mask; and modifying the corrupted digital medium stream in accordance with the corruption mask by applying a second n-state logic function that reverses the first n-state function to decorrupt the corrupted n-state symbol.

In accordance with yet a further aspect of the present invention a system is provided, wherein the sequence generator generates k-state symbols with k>2.

In accordance with yet a further aspect of the present invention a system is provided, wherein the sequence generator is a k-state maximum length sequence generator.

In accordance with yet a further aspect of the present invention a system is provided, wherein the n-state logic function is a two argument logic function.

In accordance with yet a further aspect of the present invention a system is provided, wherein the n-state logic function is an n-state inverter, selected from a plurality of n-state inverters.

In accordance with yet a further aspect of the present invention a system is provided, wherein the digital medium stream represents an image.

In accordance with yet a further aspect of the present invention a system is provided, wherein the digital medium stream represents an audio stream.

In accordance with yet a further aspect of the present invention a system is provided, wherein an instruction to decorrupt is provided through an authorized channel.

In accordance with yet a further aspect of the present invention a system is provided, wherein an authorization to decorrupt the corrupted digital media stream is provided by authorizing paying an amount of money.

In accordance with yet a further aspect of the present invention a system is provided, wherein modifying the corrupted digital medium stream takes place in real time.

In accordance with yet a further aspect of the present invention, an apparatus is provided to process a corrupted digital medium stream of symbols, each symbol being represented by one or more signals, comprising: a memory enabled to store and provide data, including instructions; a processor configured to retrieve instructions from the memory and to execute the retrieved instructions to perform the steps: receiving the corrupted digital medium stream which contains a plurality of corrupted n-state symbols with n>2; generating a corruption mask by applying a sequence of symbols; identifying the plurality of corrupted n-state symbols by applying the corruption mask; and decorrupting at least one n-state symbol in the identified plurality of corrupted n-state symbols by applying an n-state logic function.

In accordance with yet a further aspect of the present invention, an apparatus is provided, wherein the sequence generator generates k-state symbols with k>2.

In accordance with yet a further aspect of the present invention, an apparatus is provided, wherein the n-state logic function is a two argument logic function.

In accordance with yet a further aspect of the present invention, an apparatus is provided, wherein the n-state logic function is an n-state inverter, selected from a plurality of n-state inverters.

In accordance with yet a further aspect of the present invention, an apparatus is provided, wherein the corrupted digital medium stream represents an image.

In accordance with yet a further aspect of the present invention, an apparatus is provided, wherein an instruction to decorrupt the corrupted digital medium stream is provided through an authorized channel.

In accordance with yet a further aspect of the present invention, an apparatus is provided, wherein decorrupting the corrupted digital medium stream takes place in real time.

In accordance with yet a further aspect of the present invention, a method is provided for processing a corrupted digital medium stream of symbols, each symbol being represented by one or more signals, comprising: receiving by a processor of the corrupted digital medium stream which contains a plurality of corrupted n-state symbols with n>2; generating by the processor of a corruption mask by applying a sequence of symbols; identifying by the processor of the plurality of corrupted n-state symbols by applying the corruption mask; and decorrupting by the processor of at least one n-state symbol in the identified plurality of corrupted n-state symbols by applying an n-state logic function.

In accordance with yet a further aspect of the present invention, a method is provided, wherein the n-state logic function is an n-state inverter, selected from a plurality of n-state inverters.

In accordance with yet a further aspect of the present invention, a method is provided, wherein the n-state logic function is a two argument logic function.

### DESCRIPTION OF THE DRAWINGS

FIG. 1 is a diagram of a matrix in accordance with an aspect of the present invention;

FIG. 2 is another diagram of a matrix in accordance with an aspect of the present invention;

FIG. 3 is a diagram of an equation solver in accordance with an aspect of the present invention;

FIG. 4 is another diagram of a matrix in accordance with an aspect of the present invention;

FIG. 5 is yet is another diagram of a matrix in accordance with an aspect of the present invention;

FIG. 6 is yet is another diagram of a matrix in accordance with an aspect of the present invention;

FIG. 7 is yet is another diagram of a matrix in accordance with an aspect of the present invention;

FIG. 8 is yet is another diagram of a matrix in accordance with an aspect of the present invention;

FIG. 9 illustrates a system that is used to perform the steps described herein in accordance with another aspect of the present invention;

FIG. 10 illustrates a storage system for writing data to a storage medium in accordance with yet another aspect of the present invention;

FIG. 11 illustrates a storage system for reading data from a storage medium in accordance with yet another aspect of the present invention;

FIGS. 12 and 13 illustrate an implementation of an n-state truth table;

FIGS. 14 and 15 illustrate a sequence of symbols with designated corrupted locations in accordance with one or more aspects of the present invention;

FIG. 16 illustrates steps performed in accordance with aspects of the present invention;

FIGS. 17 and 18 illustrate corruption masks in accordance with aspects of the present invention;

FIG. 19 illustrates an illustrative image that is to be corrupted;

FIG. 20 shows a screenshot of a program;

FIG. 21 illustrates a corruption mask generated in accordance with an aspect of the present invention;

FIG. 22A, FIG. 22B and FIG. 22C each show a screenshot of a program that performs steps in accordance with one or more aspects of the present invention;

FIG. 23 illustrates the image of FIG. 19 corrupted in accordance with the mask of FIG.

FIG. 24 shows a screenshot of a program provided in accordance with an aspect of the present invention;

FIG. 25 shows a corruption mask that is applied to the image of FIG. 19 to generate corrupted image of FIG. 26.

FIG. 27 shows the image as a result of decorrupting the image of FIG. 26.

FIG. 28 illustrates a network in accordance with an aspect of the present invention; and

FIG. 29 illustrates a system in accordance with an aspect of the present invention.

### DESCRIPTION OF A PREFERRED EMBODIMENT

According to one aspect of the present invention, an error correcting code is provided for a matrix of multi-state symbols enhanced with check symbols.

Herein, the terms multi-state, n-state, multi-valued and n-valued symbol will mean a symbol which may assume one of 3 or more states, which distinguishes it from binary symbols or bits which can only assume one of 2 states. Furthermore, the terms state or value and multi-state or multi-valued will be used interchangeably. The logic functions that are provided herein represent the switching of states. A state may be represented by a digit or a number. This may create the impression that an actual value is attached to a state. One may, to better visualize states, assign a value to a state. However, that is not a requirement for a state. A name or designation of a state is just to indicate that it is different from states with different designations. Because some logic functions herein represent an adder the names state and value may be used meaning the same.

Furthermore, because of the practice in binary logic to represent a state by a physical level of a signal such as a voltage, one often assumes that different n-state signals have different levels of a signal, such as voltage or intensity. While such representations of a state are allowed it is not limited to that. A state may be represented by independent phenomena. For instance, different states of a signal may be represented by different wavelengths of an optical signal. A state may also be represented by a presence of a certain material, by a quantum-mechanical phenomenon, or by any other phenomenon that can distinguish a state from another state.

Furthermore, a symbol, which is regarded herein as a single element, may also be represented by 2 or more p-state symbols wherein p<n. For instance, a 4-state symbol may be represented by 2 binary symbols.

The generation of check symbols, especially in sequences of binary symbols, is known, and either a parity symbol or a combination of symbols representing a checksum is generated. One may also generate n-valued check symbols by applying n-valued symbols to one or more n-valued logic functions. For instance, one may have a sequence of 4 4-valued data symbols [d1 d2 d3 d4]. One may create a check symbol c (or the fifth symbol in the sequence) by for instance adding modulo-4 the value (or representation of the state of each data symbol) of each data symbol. One has thus created the sequence [d1 d2 d3 d4 c]. Assume d1=0; d2=2; d3=2; and d4=3. Then c=(d1+d2+d3+d4)mod-4=(7)mod-4=3.

This is merely an example. The symbols are n-state, with at this stage no limitation to the number of states (just n>2). The functions can be any n-valued switching function, related to the n-state of the symbols. For error correction an n-valued function for determining a check symbol is preferably a reversible n-valued logic function. While it seems strange, one may also solve equations with non-reversible n-valued logic functions. A non-reversible n-valued logic function has a truth table with at least one row or column that has two identical output states for different input states. By providing sufficient different equations one can address the uncertainty related to the states of for instance inputs (x1, x2) and (x1, x3) generating the same output state d1.

In accordance with a further aspect of the present invention, one should arrange a sequence of symbols in a matrix. For instance a sequence of 9 multi-state symbols d12, d12, d13, d21, d22, d23, d31, d32 and d33 can be arranged in a 2-dimensional matrix as shown in FIG. 1 having rows and columns. To each row of data symbols at least one check symbol qi (q1, q2 and q3) is added. Further more to each column 2 check symbols p and p are added. Each check symbol is created from data symbols in its respective row or column. One may also create a first check symbol from data symbols and a second symbol from data symbols and the first check symbol. FIG. 1 is merely an illustrative example. One may have a multi-dimensional matrix (more than 2 dimensions). Multi-dimensional matrices are fully contemplated and the term row and column are extended to other dimensions in a multi-dimensional matrix. One may have more or fewer check symbols per column or row. One may have no check symbols in one or more rows or columns. One may also have a different number of check symbols in each row or each column.

The position of a check symbol in a row or a column is shown for illustrative purposes at the end of a row or the bottom of a column. It should be clear that one may position a check symbol anywhere in a matrix as long as one knows from which data symbols a check symbol is determined.

A sequence of symbols can be arranged in a matrix for analysis and determination of check symbols. It should be clear that the symbols are usually not transmitted in a matrix. One does not have to arrange symbols in an actual matrix for analysis. It is required that one knows the relationships between data symbols and check symbols and how two or more different check symbols may have at least one data symbol in common.

A preferred embodiment as one aspect of the present invention, is to first identify which symbols in a matrix are possibly in error, and based on a selected coding scheme reconstruct the symbols that were detected as being possibly in error by using reversing equations. Assume that in a 2-dimensional matrix each row has p check symbols and each column has q check symbols and no more than q rows or no more than p columns are in error one may solve up to p×q errors in a deterministic manner. A row or a column being in error herein means that a row or a column has at least one check symbol which after being recalculated has a value or state different from its received value. With more columns or rows in error one may apply an iterative scheme, based on making an initial assumption about at least one symbol that can possibly be in error in actuality not being in error. Based on such an assumption one may then calculate the values or states of remaining symbols that may be in error. If the thus calculated values result in an error free matrix there is a high probability that the assumption was correct and that the calculated values are correct. If such an assumption leads to a matrix still containing errors there is a high probability that the assumption was wrong and a different assumption has to be tried, until an error free matrix is achieved.

The advantage of a Reed Solomon code is that each word having 2×k check symbols may correct up to k errors. However in light of the complexity of solving for instance an error location polynomial, solving errors is a relatively complex process. If one can identify location of errors, reconstruction of the symbol in errors is relatively simple.

Reconstruction of symbols (including n-valued symbols) in error based on known correct symbols has been demonstrated by the Applicant in U.S. patent application Ser. No. 11/566,725, filed on Dec. 5, 2006 entitled ERROR CORRECTING DECODING FOR CONVOLUTIONAL AND RECURSIVE SYSTEMATIC CONVOLUTIONAL ENCODED SEQUENCES, which is incorporated herein in its entirety by reference. Reconstruction of symbols in error in Reed Solomon codes and in what the Applicant calls Reed-Solomon like codes also are described in U.S. Non-provisional patent application Ser. No. 11/739,189, filed on Apr. 24, 2007, which claims the benefit of U.S. Provisional Patent Application Ser. No. 60/807,087 filed Jul. 12, 2006; U.S. Non-provisional patent application Ser. No. 11/743,893, filed on May 3, 2007, which claims the benefit of U.S. Provisional Patent Application Ser. No. 60/821,980 filed Aug. 10, 2006, which are all four incorporated herein by reference in their entirety.

Especially in a matrix wherein errors are distributed in such a way that only a limited number of rows or columns (or on dimensions in a multi-dimensional matrix) are in error, the use of Reed Solomon codes may be excessive and use of error detection and symbol reconstruction as provided herein as an aspect of the present invention may be simpler and more effective, achieving a bigger “bang-for-the-buck” so to speak for each check symbol.

The issue with matrix based codes is that multiple errors may hide errors by creating a check symbol that appears to be correct. Assume that the previously provided example before transmission creates the sequence: [d1 d2 d3 d4 c]. Wherein d1=0; d2=2; d3=2; and d4=3 and c=(d1+d2+d3+d4)mod- 4=(7)mod-4=3. Accordingly, [d1 d2 d3 d4 c]=[0 2 2 3 3]. Assume that after transmission one receives [0 2 3 2 3]. Both d3 and d4 are in error. However when one recalculates the check symbol one determines c=3. Based on that it is impossible to determine that two errors have occurred. The errors cancel each other out in determining the check symbol. In other words the errors are hidden. It was shown by the inventor in U.S. patent application Ser. No. 11/969,560 filed on Jan. 4, 2008, which is incorporated herein by reference, that errors in a matrix code can be unhidden by applying check symbols which are determined from different arrangements of symbols in a matrix.

In accordance with an aspect of the present invention, one can solve a set of p errors in a plurality of symbols if one has p independent equations wherein the p symbols in errors are the unknowns.

### Independent Equations for Determining Check Symbols

Binary check symbols or parity bits are based on a limited relationship between the constituting bits. The relationship is commonly established by the binary XOR function. N-valued check symbols can have more varied reversible relationships as was explained in the earlier cited application Ser. No. 11/680,719. For instance one may have a word of 4 n-valued symbols [a b c d]. One may create a first n-valued check symbol c1=a⊕b⊕c⊕d. One may also create a second check symbol c2=a⊕b⊕c⊕d. If only one of the symbols a, b, c or d is in error one can reconstruct the symbol in error both from c1 or c2 if these are not in error and both ⊕ and \textcircled{x} are reversible operations. It should also be clear that two symbols in error can be reconstructed if the equations for c1 and c2 are independent and the operations are reversible. Calculation of c1 and c2 by ⊕ and \textcircled{x} may be independent because the operations are different and/or independent. The equations for c1 and c2 may be independent because the symbols a, b, c and d are processed with the same function but with for instance different n-valued inverters. For instance, c2=a⊕2b⊕3c⊕2d in an n-valued code. The advantage of using n-valued coders with LFSRs either in Galois or in Fibonacci configuration is that each next generated check symbol has an independent equation from another check symbol in the code. That is a reason why Reed Solomon (RS) codes work as error correcting codes.

The advantage of using an LFSR is that one does not need to execute each expression or equation in full to generate a check symbol. The appropriate configuration of the LFSR takes care of generating the check symbols in accordance with independent expressions or equations. The drawback of the RS code is that the location of an error first has to be found by for instance solving an error correction polynomial. In order to be able to do that for each error there have to be 2 check symbols. By knowing where the errors occur, for instance by using a matrix with error symbols derived from columns and rows, one may be able to use just one check symbol per error.

### Methods for Solving N-Valued Error Equations

There are actually several different methods to solve the n-valued error equations. Which method one applies may depend on the complexity of the equations, the properties of the functions and which of the symbols are in error. The complexity and properties of functions is directly related to the value of n. For instance, if n=2^{p} then one can use a function sc1 which is an addition over GF(2^{p}) and multipliers over GF(2^{p}). In that case sc1 is self-reversing, commutative and associative. This makes solving equations much easier. An illustrative example will be provided.

Under conditions where the position of an error symbol can be determined unambiguously, it is also possible to solve the equations unambiguously. If for some reason it is impossible or undesirable to solve equations in an algebraic fashion, one can solve the equations iteratively by using all possible values for the symbols in error. One will find only one combination of values that solves all equations correctly.

One method is to solve the equations in an algebraic fashion. In order to solve equations it is useful to review the rules for reversible, non-commutative and non-associative n-valued logic functions. Assume n-valued logic function ‘sc’ to be reversible, non-commutative and non-associative.

When (a sc b=c) then (b sc^{T} a=c), with the truth table of sc^{T} being the transposed of the truth table of sc.
When (a sc b=c) then (c scrc b=a), with the function ‘scrc’ being the reverse of ‘sc’ over constant columns.
When (a sc b=c) then (a scrr c=b), with the function ‘scrr’ being the reverse of ‘sc’ over constant rows.
When (b sc^{T} a=c) then (b sc^{T}rr c=a), etc.

Assume a coder using 3 data symbols x1, x2 and x3 and generating two check symbols p1 and p2 using the following two equations for generating p1 and p2: p1={x1 sc2 (x2 sc1 x3)} and p2={p1 sc2 (x1 sc1 x2)}.

Algebraic method. As a first 4-valued example, assume that of [x1 x2 x3 p1 p2]x3 and p1 are in error. Clearly a first simple step is to solve p2={p1 sc2 (x1 sc1 x2)} which has p1 as unknown. One can rewrite the equation as: {p2 sc2rc (x1 sc1 x2)}=p1. The truth tables of sc1 and sc2 are provided in the following tables.

| sc1 | 0 | 1 | 2 | 3 |
|---|---|---|---|---|
| 0 | 0 | 1 | 2 | 3 |
| 1 | 1 | 0 | 3 | 2 |
| 2 | 2 | 3 | 0 | 1 |
| 3 | 3 | 2 | 1 | 0 |

| sc2 | 0 | 1 | 2 | 3 |
|---|---|---|---|---|
| 0 | 0 | 1 | 2 | 3 |
| 1 | 2 | 3 | 0 | 1 |
| 2 | 3 | 2 | 1 | 0 |
| 3 | 1 | 0 | 3 | 2 |

Herein the function sc2rc is the reverse of sc2 over constant columns. Its truth table is provided in the following table.

| sc2rc | 0 | 1 | 2 | 3 |
|---|---|---|---|---|
| 0 | 0 | 3 | 1 | 2 |
| 1 | 3 | 0 | 2 | 1 |
| 2 | 1 | 2 | 0 | 3 |
| 3 | 2 | 1 | 3 | 0 |

The assumption was that x3 and p1 were in error, so in the example the received codeword was [3 3 x3 p1 0] using the earlier example. Filling in the values in the equation provides p1={0 sc2rc (3 sc1 3)} or p1=0 sc2rc 0=0.

From p1={x1 sc2 (x2 sc1 x3)} wherein now only x3 is an unknown one can derive: (x2 sc1 x3)={x1 sc2rr p1} wherein sc2rr is the reverse of sc2 over constant rows. Keeping in mind that sc1 is self reversing: x3=x2 sc1 (x1 sc2rr p1). The truth table of sc2rr is provided in the following table.

| sc2rr | 0 | 1 | 2 | 3 |
|---|---|---|---|---|
| 0 | 0 | 1 | 2 | 3 |
| 1 | 2 | 3 | 0 | 1 |
| 2 | 3 | 2 | 1 | 0 |
| 3 | 1 | 0 | 3 | 2 |

Thus, x3=x2 sc1 (x1 sc2rr p1) leads to: x3=3 sc1 (3 sc2rr 0) or x3=3 sc1 1=2.

One may apply the same approach when x2 and x3 are in error. In that case, one may apply p2={p1 sc2 (x1 sc1 x2)} to achieve (x1 sc1 x2)=p1 sc2rr p2 and thus achieve x2=x1 sc1 (p1 sc2rr p2). This will provide x2=3. Etc.

A more difficult situation occurs when x1 and x2 are determined to be in error. The equations will be fairly difficult to solve. Assume that x1=e1 and x2=e2. The equations will then be:

p1={e1 sc2 (e2 sc1 x3)} and

p2={p1 sc2 (e1 sc1 e2)}.

The value of p1 and p2 are correct. So one way to solve the equation in an iterative manner is to solve the equations:

t1={e1 sc2 (e2 sc1 x3)} and

t2={p1 sc2 (e1 sc1 e2)}

for all values of e1 and e2, and determine for which values of (e1,e2) the value (p1−t1) and (p2−t2) are both 0. Not surprisingly this will be the case for (e1,e2)=(3,3). This is a time consuming and not very elegant way to solve the problem, and may be a solution of last resort.

Fortunately for codes with for instance check symbols generated over GF(2^{p}), one can also use a different approach. Within GF(2^{p}) the addition can be a self reversing, commutative and associative function. An LFSR in GF(2^{p}) can be realized with functions which are a combination of adders with multipliers to generate check symbols. One may also generate check symbols by evaluating an expression that determines the check symbol. One can reduce the functions by reduction of the truth tables according to the multipliers. This makes the execution of the coder quicker. In order to solve the equations one can revert back to associative adders with multipliers.

The need for solving errors of 2 symbols in a word may be because of the spill-over effect when one codes a symbol as for instance a binary word. One can never be sure that only an error in one symbol has occurred, so one should be prepared to solve the equations for two adjacent n-valued symbols in error. It is also possible that two errors have occurred in non adjacent symbols in a word. This assumes a different error behavior than for adjacent errors. Especially codewords generated by LFSRs (Galois and Fibonacci) that can be created by additions (with or without multipliers) over GF(2^{p}), have easier to solve equations because of the associative properties of the addition function.

For instance, assume using again a 4-valued illustrative example wherein x1 and p1 are found to be in error. The generating expressions were: p1={x1 sc2 (x2 sc1 x3)} and p2={p1 sc2 (x1 sc1 x2)}. Assume an inverter inv2=[0 2 3 1] which is a 4-valued multiplier over GF(4). One can easily check that the inverter is multiplication over GF(4) with a factor 2. It can be checked that the function (a sc2 b) can be replaced by (inv2(a) sc1 b). One can then replace the generating expressions by the next expressions: p1={xt1 sc1 (x2 sc1 x3)} and p2={p1 sc1 (x1 sc1 x2)} using the earlier defined functions. Herein xt1=inv2(x1) and pt1=inv2(p1) and sc1 commutative, self-reversing and associative. The way to approach this is to use arithmetic in GF(2²). The following rules apply using + and × in GF(2²).

$$\begin{matrix}\times & 0 & 1 & 2 & 3 \\ 0 & 0 & 0 & 0 & 0 \\ 1 & 0 & 1 & 2 & 3 \\ 2 & 0 & 2 & 3 & 1 \\ 3 & 0 & 3 & 1 & 2\end{matrix}$$

Accordingly multiplication can be shown as:

$$\begin{matrix} & & 1 & 2 & 3 \\ \times & 1 & 1 & 2 & 3 \\ \times & 2 & 2 & 3 & 1 \\ \times & 3 & 3 & 1 & 2\end{matrix}$$

For instance, in GF(2²) under the earlier defined multiplication 2×2 x1=3x1, etc.

### Addition

$$\begin{matrix}+ & x 1 & 2 \times 1 & 3 \times 1 \\ x 1 & x 1 + x 1 = 0 & x 1 + 2 \times 1 = 3 \times 1 & x 1 + 3 \times 1 = 2 \times 1 \\ 2 \times 1 & 2 \times 1 + x + 1 = 0 & 2 \times 1 + 2 \times 1 = 0 & 2 \times 1 + 3 \times 1 = x 1 \\ 3 \times 1 & 3 \times 1 + x 1 = 2 \times 1 & 3 \times 1 + 2 \times 1 = x 1 & 3 \times 1 + 3 \times 1 = 0\end{matrix}$$

The distributive property applies to a×(b+c)=a×b+a×c.
Division is the inverse of multiplying.

$$\begin{matrix} \div & 1 & 2 & 3 \\ & 1 & 3 & 2\end{matrix}$$

Accordingly, division by 1 is multiplying by 1; division by 2 is multiplying by 3; and division by 3 is multiplying by 2.

One can then write the equations as p1=2×x1+x2+x3 and p2=2×p1+x1+x2.

For instance, assume that x1 and x2 are known to be in error. Then x2=2×x1+x3+p1. Substitute in the p2 equation: p2=2×p1+x1+(2×x1+x3+p1) or 2×x1+x1=2×p1+p1+p2+x3, or 3×x1=3×p1+p2+x3. Dividing by 3 is multiplying by 2 so: x1=p1+2×p2+2×x3=0+2×0+2×2=3. Etc.

As another example, one may assume that not adjacent symbols x1 and p1 are in error. One must solve the equations then for x1. This leads to 2×x1=3×x2+2×x3+p2; or x1=2×x2+x3+3×p2=2×3+2+0=1+2=3. One achieves this result by applying the arithmetic rules in GF(2²) as stated before.

Galois field arithmetic may be preferred for solving the equations for in error symbols. However, these easy solutions may only be available for codewords defined in extension binary fields.

As an illustrative example, a 5 symbol 5-valued code will be generated with 3 data symbols and two check symbols generated by using 5-state switching function sc5, which is the mod-5 addition with the following truth table.

| sc5 | 0 | 1 | 2 | 3 | 4 |
|---|---|---|---|---|---|
| 0 | 0 | 1 | 2 | 3 | 4 |
| 1 | 1 | 2 | 3 | 4 | 0 |
| 2 | 2 | 3 | 4 | 0 | 1 |
| 3 | 3 | 4 | 0 | 1 | 2 |
| 4 | 4 | 0 | 1 | 2 | 3 |

The 5-valued equations for generating check symbols p1 and p2 are: p1={x1 sc5 (x2 sc5 2×x3)} and p2={p1 sc5 (x1 sc5 2×x2)} to generate codeword [x1 x2 x3 p1 p2]. Because sc5 is an addition (mod-5) one can write the equations as: p1=x1+x2+2×x3 and p2=p1+x1+2×x2. The check symbols can be generated by an LFSR.

For the 5-valued arithmetic the following truth table need to be used for multiplication × and subtraction −, meaning (a-b) wherein ‘a’ is the row and ‘b’ is the column of the truth table.

| | | | | | |
|---|---|---|---|---|---|
| − | 0 | 1 | 2 | 3 | 4 |
| 0 | 0 | 4 | 3 | 2 | 1 |
| 1 | 1 | 0 | 4 | 3 | 2 |
| 2 | 2 | 1 | 0 | 4 | 3 |
| 3 | 3 | 2 | 1 | 0 | 4 |
| 4 | 4 | 3 | 2 | 1 | 0 |
| × | 0 | 1 | 2 | 3 | 4 |
| 0 | 0 | 0 | 0 | 0 | 0 |
| 1 | 0 | 1 | 2 | 3 | 4 |
| 2 | 0 | 2 | 4 | 1 | 3 |
| 3 | 0 | 3 | 1 | 4 | 2 |
| 4 | 0 | 4 | 3 | 2 | 1 |

One should further keep in mind that dividing by 2 is multiplying with 3, dividing by 3 is multiplying by 2 and dividing by 4 is multiplying by 4. Further more 3×3=4 and 4×4=1, etc.

Accordingly, one will find for x1: p2=2x1+3x2+2x3 or 3p2=x1+4×2+x3 or x1=(3p2−4×2)−x3. The data symbols [x1 x2 x3]=[0 4 3] will generate [p1 p2]=[0 3]. One may calculate x1 and p1 from the other symbols (for instance when they are in error). The equation correctly provides: x1=(3×3−4×4)−3=(4−1)−3=0.

The methods here presented as different aspects of the present invention also apply to detection and correction of more than 2 errors, such as three errors. In order to detect k errors in a codeword of n symbols, each codeword in a set of codewords must have at least k+1 different symbols in common positions from any other codeword in the set. Or each codeword may at most have (n−k−1) symbols in common positions. The best one can do in a 7 symbol codeword to detect 3 errors is having at most 3 symbols in common. Such a code would require 8-valued symbols and is generally known as an RS-code. It is possible to meet the error detection requirement in a lower valued symbol codeword. However, that would require a codeword with more symbols. It is then understood that other and different examples of detection 3 errors in a codeword can be provided according to different aspects of the present invention.

As an illustrative example, an 8-valued 7 symbol codeword with 3 check symbols will be provided to demonstrate error correction when the position of errors is known.

One can identify the positions of the errors for instance by establishing a matrix as shown in FIG. 2. The data symbols occur sequentially as x1 . . . x4, y1 . . . y4, v1 . . . v4, z1 . . . z4. The symbols are broken up as 4 columns of 4 data symbols and horizontal check symbols t and tt are generated as well as vertical check symbols p, q, and r. The symbols tt are check symbols on the check symbols. The assumption in the example is that errors will occur as at most 3 errors in a column. One skilled in the art may, of course, design 2 or 3 dimensional matrices for different (also non adjacent) errors and different symbol error ratios as well as different codeword sizes.

Assume that all symbols in the illustrative examples are 8-valued. By running 8-valued coders on the received data symbols one can check the newly generated check symbols against the received check symbols and determine which rows and columns are in error, thus determining the position of the errors. Based on the known error positions and the coder one can reconstruct the correct symbols in the error positions.

The truth tables of the addition sc1 and multiplier over GF(2³) are provided in the following truth tables.

| + | 0 | 1 | 2 | 3 | 4 | 5 | 6 | 7 |
|---|---|---|---|---|---|---|---|---|
| 0 | 0 | 1 | 2 | 3 | 4 | 5 | 6 | 7 |
| 1 | 1 | 0 | 4 | 7 | 2 | 6 | 5 | 3 |
| 2 | 2 | 4 | 0 | 5 | 1 | 3 | 7 | 6 |
| 3 | 3 | 7 | 5 | 0 | 6 | 2 | 4 | 1 |
| 4 | 4 | 2 | 1 | 6 | 0 | 7 | 3 | 5 |
| 5 | 5 | 6 | 3 | 2 | 7 | 0 | 1 | 4 |
| 6 | 6 | 5 | 7 | 4 | 3 | 1 | 0 | 2 |
| 7 | 7 | 3 | 6 | 1 | 5 | 4 | 2 | 0 |

| × | 0 | 1 | 2 | 3 | 4 | 5 | 6 | 7 |
|---|---|---|---|---|---|---|---|---|
| 0 | 0 | 0 | 0 | 0 | 0 | 0 | 0 | 0 |
| 1 | 0 | 1 | 2 | 3 | 4 | 5 | 6 | 7 |
| 2 | 0 | 2 | 3 | 4 | 5 | 6 | 7 | 1 |
| 3 | 0 | 3 | 4 | 5 | 6 | 7 | 1 | 2 |
| 4 | 0 | 4 | 5 | 6 | 7 | 1 | 2 | 3 |
| 5 | 0 | 5 | 6 | 7 | 1 | 2 | 3 | 4 |
| 6 | 0 | 6 | 7 | 1 | 2 | 3 | 4 | 5 |
| 7 | 0 | 7 | 1 | 2 | 3 | 4 | 5 | 6 |

The following table shows the division rule in GF(2³).

| | | | | | | | |
|---|---|---|---|---|---|---|---|
| ÷ | 1 | 2 | 3 | 4 | 5 | 6 | 7 |
| × | 1 | 7 | 6 | 5 | 4 | 3 | 2 |

Or division by 2 is multiplying by 7, division by 3 is multiplying by 6, etc.

Four data symbols [x y v z] in a column will generate 3 check symbols [p q r]. The equations for generating the check symbols are:

p=4x+y+y+2z;

q=4p+x+y+2v;

r=4q+p+x+2y.

The above check symbols may also be generated by an 8-valued LFSR. One can solve these equations for any of the 3 symbols to be unknown. As one example assume [x y v] to be in error. One can solve the linear equations by matrices or by substitution. Applying substitution one will find:

v=7p+4q+5r+z;

y=6p+6q+5r+6v;

x=p+4q+r+2y;

and thus with symbols [z p q r] known and error-free one can solve the equations.

A partial set of 7 8-valued symbol codeword generated by the above expressions is shown in the following table.

| x | y | v | z | p | q | r |
|---|---|---|---|---|---|---|
| 0 | 4 | 7 | 2 | 2 | 3 | 4 |
| 1 | 3 | 7 | 1 | 0 | 3 | 7 |
| 2 | 5 | 6 | 4 | 1 | 2 | 2 |
| 3 | 5 | 4 | 2 | 5 | 7 | 1 |
| 4 | 3 | 7 | 1 | 5 | 6 | 3 |
| 5 | 4 | 6 | 6 | 0 | 0 | 0 |
| 6 | 3 | 4 | 0 | 7 | 1 | 2 |
| 7 | 7 | 2 | 4 | 7 | 0 | 1 |

One can easily check for the provided codewords using [z p q r] in the equations to determine [x y z].

One can provide the solution set for any of 3 or less symbols in a codeword being in error.

One may also determine solutions for independent sets of unknowns by applying Cramer's rule. As an example, the set of equations for the above coder will be used. For application of Cramer's rule one should apply all additions and multiplications of this example in GF(8). When applying Cramer's rule using for other radix-n one should apply the appropriate arithmetic. In this example, one should apply addition and multiplication over GF(2³) of which the truth tables are provided above.

Assume that it is determined that x, y and z are in error. The codeword in error is [x y v z p q r]=[e1 e2 7 e4 5 6 3]. One should the create three equations with unknowns x1, x2 and x4 from the known equations as:

4x+y+2z=p+v

x+y+0=4p+q+2v

x+2y+0=p+4q+r

Cramer's rule then solves the above equations as:

$$x = \frac{\vert \begin{matrix}d 1 & 1 & 2 \\ d 2 & 1 & 0 \\ d 3 & 2 & 0\end{matrix} \vert}{D}$$

$$y = \frac{\vert \begin{matrix}4 & d 1 & 2 \\ 1 & d 2 & 0 \\ 1 & d 3 & 0\end{matrix} \vert}{D}$$

$$z = \frac{\vert \begin{matrix}4 & 1 & d 1 \\ 1 & 1 & d 2 \\ 1 & 2 & d 3\end{matrix} \vert}{D}$$

Herein

$$\begin{matrix}D = \vert \begin{matrix}4 & 1 & 2 \\ 1 & 1 & 0 \\ 1 & 2 & 0\end{matrix} \vert \\ = 4 * \vert \begin{matrix}1 & 0 \\ 2 & 0\end{matrix} \vert + 1 * \vert \begin{matrix}1 & 0 \\ 1 & 0\end{matrix} \vert + 2 * \vert \begin{matrix}1 & 1 \\ 1 & 2\end{matrix} \vert \\ = 0 + 0 + 2 * ( 1 + 2 ) \\ = 2 * 4 \\ = 5 ,\end{matrix}$$

as the rules of GF(8) are used.

Furthermore,

$$\begin{matrix}( \begin{matrix}d 1 \\ d 2 \\ d 3\end{matrix} ) = ( \begin{matrix}p + v \\ 4 p + q + 2 v \\ p + 4 q + r\end{matrix} ) \\ = ( \begin{matrix}4 \\ 6 \\ 0\end{matrix} )\end{matrix}$$

Accordingly,

$$\begin{matrix}x = \frac{2}{5} \\ = 4 ;\end{matrix}$$

$$\begin{matrix}y = \frac{7}{5} \\ = 3\end{matrix}$$

$$and$$

$$\begin{matrix}z = \frac{5}{5} \\ = 1.\end{matrix}$$

This is in accordance with the elements in the word as generated by FIG. 9.

One may also apply Cramer's rule to other n-valued codes, such as the 5-valued coder of above. Herein, one should use the rules of modulo-5 addition and modulo-5 subtraction in the provided example, as well as the proper multiplication. Assuming that in a codeword [x1 x2 x3 p1 p2] the symbols x2, p1 and p2 are correct and x1 and x3 are in error the equations become:

x1+2x3=p1−x2

x1+0=p2−p1−2×2.

The determinant

$$\begin{matrix}D = \vert \begin{matrix}1 & 2 \\ 1 & 0\end{matrix} \vert \\ = 1 * 0 - 2 * 1 \\ = - 2 \\ = 3.\end{matrix}$$

The solution vector is

$$( \begin{matrix}d 1 \\ d 2\end{matrix} ) = ( \begin{matrix}p 1 - x 2 \\ p 2 - p 1 - 2 \times 2 \end{matrix} )$$

Assume that the codeword [x1 x2 x3 p1 p2]=[e1 4 e3 2 0] was received. According to Cramer's rule:

$$\begin{matrix}x 1 = \frac{\vert \begin{matrix}d 1 & 2 \\ d 2 & 0\end{matrix} \vert}{D} \\ = \frac{\vert \begin{matrix}3 & 2 \\ 0 & 0\end{matrix} \vert}{3} \\ = 0 ,\end{matrix}$$

$$and$$

$$\begin{matrix}x 3 = \frac{\vert \begin{matrix}1 & d 1 \\ 1 & d 2\end{matrix} \vert}{D} \\ = \frac{\vert \begin{matrix}1 & 3 \\ 1 & 0\end{matrix} \vert}{3} \\ = \frac{1 * 0 - 3 * 1}{3} \\ = \frac{- 3}{3} \\ = - 1 \\ = 4.\end{matrix}$$

Accordingly, the correct codeword is [x1 x2 x3 p1 p2]=[0 4 4 2 0]. It is thus demonstrated that as long as the position of errors are known one may correct any set of errors within the constraints of the number of independent equations.

For illustrative purposes errors are solved by using n-valued adders and multiplications, either modulo-n or over GF(n). An n-valued multiplication with a constant may be dealt with as an n-valued inverter. One may reduce combinations of n-valued inverters and an n-valued logic function to a function with a modified truth table as was shown by the inventor in U.S. patent application Ser. No. 10/935,960, filed on Sep. 8, 2004, which is incorporated herein by reference. An expression for a check symbol cs1=inv2(x1) sc5 inv3(x2) sc5 inv4(x3) may then be replaced by sc 1=x1 sc51 x2 sc52, wherein sc51 and sc52 are the function sc5 modified in accordance with the inverters. This reduction may be applied to any expression having inverters and functions, including modulo-n adders and multipliers and adders and multipliers over GF(n). Accordingly, an n-valued expression created from adders and having at least one multiplier may be changed to an expression having at least one function not being an adder modulo-n or over GF(n). A function not being an adder over GF(n) or a modulo-n adder herein may be defined as an n-valued non-adder function.

In accordance with an aspect of the present invention, one may thus circumvent using an adder and multiplication by using an n-valued non-adder function in an expression to solve an error. Such an expression may be part of Cramer's rule.

Furthermore, one may overestimate the number of errors within the constraints. For instance, if only x1 was in error and x3 was not in error but the other conditions still apply then one still will reconstruct the correct value for x3. Even though x3 was not in error.

It is fairly simple to calculate the symbols in error ‘on-the-fly’, based on the errors. One can also already implement each set of solutions based on the maximum number of errors. Assuming 3 symbols in error even if only one is in error does not matter to the final error correction. One merely recalculates the symbols. The only limitation is that one of course can not solve in a deterministic way more errors than independent equations. One can again see the clear advantage here of knowing where the errors are located. It cuts the number of required check symbols in half, as compared to an RS code for instance.

FIG. 3 provides a diagram for solving different equations depending on different errors. One can store the equations for specific combinations of errors. As an example, it is assumed that at most 3 consecutive symbols can be in error. For each error combination a solution set is determined a stored for instance as an executable program or is hard wired as a circuit. Assume a codeword having 10 data symbols and 3 check symbols and each codeword of the set has at most 9 symbols in common with another codeword. Assume that, for instance, through using also horizontal error check symbols one can determine where errors occur in a column 1000 in FIG. 3. Assume that errors occurred in position 1001 or in the first 3 symbols of the codeword. The solution for this situation is enabled as ‘solution 1’ in equation solver 1010. This equation solver may be part of a computer program or hard wired logic circuits. The solver is then provided with the known correct symbols [x4 x5 x6 x7 x8 x9 x10 p1 p2 p3] and then generates the correct [x1 x2 x3].

Such a circuit or computer program may calculate a value. This may be achieved by n-valued or n-state circuits or devices. It may also be achieved by binary circuitry, wherein an n-state symbol is represented in binary form. Ultimately, the solver will generate the correct state for the symbols in error. The correct symbols may be generated as n-state signals, or in a binary signal representation or in any other signal representation that can be used to represent the corrected symbol. After error correction, a symbol in binary representation may for instance be converted into an n-state signal by applying a Digital/Analog converter as is well known to one of ordinary skill in the art. A symbol in binary representation may also be further processed in binary form. After error correction, the complete set of symbols as received and corrected is then available for further processing by digital devices or a processor or any other digital signal processing device. Accordingly, actual devices are used. One requires signals for further processing. For instance the received and corrected n-valued symbols may be processed an converted and provided by a device into an audio signal. It may also be used to generate a video signal, a radar signal, or any other useful signal. The methods and apparatus to correct n-valued signals or representations of n-valued or n-state signals are useful, as they prevent from errors to occur in for instance audio and/or video signals and thus prevent a negative experience by the user of such audio or video signals. In one embodiment an apparatus evaluates and/or processes at least 100 n-state check symbols per second. In another embodiment an apparatus evaluates and/or processes at least 1000 n-state check symbols per second. In yet another embodiment an apparatus evaluates and/or processes at least 100,000 n-state check symbols per second. In yet another embodiment an apparatus evaluates and/or processes at least one million n-state check symbols per second.

For another error situation 1002 the solver addresses a different ‘solution 2’ and generates [x5 x6 x7] and for error situation 1003 the solver addresses yet another ‘solution 3’ which may generate just x10 or also [p1 p2] if those symbols are used in a later stage.

### Checking the Check Symbols

It has been shown that n-state symbols in error can be corrected once their location is known. In this section as an aspect of the present invention a method is provided to detect multiple errors over a dimension of a matrix and to provide possible locations of symbols in errors. Based on the location one may calculate directly the magnitude of an error (by using a syndrome) or the correct value of a symbol in error. When a dimension of a matrix (such as a row or a column) contains many data symbols of which only a few are in error it may reduce the number of calculations by first determining a magnitude of an error and then correct the symbol in error by that magnitude.

If a dimension of a matrix such as a row or a column has p check symbols of which each check symbol is generated of an independent equation compared to the other check symbols then always p symbols in error can be detected. Errors in such a case cannot cancel each other out. During coding the check symbols are calculated. The symbols are then processed, stored or transmitted. After receiving the processed, stored or transmitted symbols the check symbols are recalculated. The existence of one and up to p symbols in error in a dimension of a matrix will create at least one recalculated check symbol which is different from a received check symbol. The dimension such as a row or column of a matrix is then called in error, and may be called a row, column or dimension in error.

Because a data symbol in a matrix shares at least two dimensions such as a row and a column, an error in a data symbol will put at least two dimensions or for instance a row and column in error. Accordingly, an error may exist at the cross point of two dimensions in error.

In a dimension in error not only data symbols may be in error. Also check symbols may be in error. If only check symbols are in error one may not care to solve the symbols in errors as the data symbols are correct. If a mix of data symbols and check symbols are in error one may have to solve all errors. It may be advantageous to assure that all check symbols are error free, for instance by applying excess check-the check symbols ‘tt’ for instance by coding the check symbols according to a Reed Solomon (RS) code. Such use of a RS-code does not fundamentally change the approach herein provided. For illustrative purposes it is assumed that in one embodiment check symbols are error free, possibly by using RS codes. This is shown schematically in FIG. 4 in a matrix code 400. Herein the data symbols are in 401. The check symbols of the rows are in 402 and of the columns in 403. Check-the check symbols are in 404. The size of block 404 reflects that additional check on check-the check symbols are included to allow error correction in the check symbols. It is to be understood that in a different embodiment one may have errors in check symbols that require correction.

### Locating and Correcting Errors in a Matrix

The problem of narrowing the location of errors in demonstrated in FIGS. 5 and 6 which show a matrix with errors related to the matrix code of FIG. 2. The check-the check symbols ‘tt’ are deliberately omitted in this illustrative example to keep focus on error location, but may be assumed.

The situation in FIG. 5 is simple. The shaded row related to check symbol t4 is in error. Also the shaded column related to p3, q3 and r3 is in error. Accordingly the symbol in error is on the crossing of this row and column: symbol z3 is in error. One may resolve the error by using one of the equations to determine the relevant check symbols as shown above.

The situation in FIG. 6 is more complicated. The shaded rows related to t2 and t4 are in error and the shaded columns related to p1 and p3 are in error. Even if it is assumed that only one error occurs in a row, this situation indicates that potentially symbols y1, y3, z1 and z3 are in error. One cannot resolve the errors over the rows in a deterministic way as each row has just one independent check symbol. However, one can resolve at least two independent equations per column. One may thus resolve y1 and z1 in the first column. In case just one symbol is in error one will find one symbol to be changed as to its received value and one symbol being the same as to its received value. The same applies to the column with y3 and z3.

One can see in FIG. 6 that two columns are in error, even though the error limitation of one error per row was not exceeded. However, the limitation of 3 rows in error was not exceeded. One may thus derive a rule for deterministic error detection and correction in a matrix code.

A row of a matrix comprising n-state data symbols may have p independent n-state check symbols. A column of the matrix comprising n-state data symbols may have q independent check symbols. If m columns are in error with m>p but not more than q rows are in error one can solve up to m×q symbols in error by assuming each symbol that is in a row or a column in error as an unknown; by solving q unknowns in a column from a set of q independent equations; and by solving all unknowns for all columns.

One may interchange the terms column and rows for the situation wherein m rows are in error with m>q but no more than q columns are in error.

One may also adapt the rule for k-dimensional matrices with k≧2. A first dimension of a k-dimensional matrix comprising n-state data symbols may have p independent n-state check symbols. A second dimension of the k-dimensional matrix comprising n-state data symbols may have q independent check symbols. If m instances of the first dimension are in error with m>p but not more than q instances of the second dimension are in error one can solve up to m×q symbols in error by assuming each symbol that is in an instance of a first and a second dimension in error as an unknown; by solving q unknowns in an instance of second dimension from a set of q independent equations; and by solving all unknowns for all instances of a second dimension.

An instance of a dimension is then a row in that dimension. An instance of a first dimension in a 2-dimensional matrix may be a row in horizontal direction, commonly called a row. An instance of a second dimension of a 2-dimensional matrix is then a row in the vertical direction or commonly called a column. An instance of a third dimension of a 3-dimensional matrix is a row that is perpendicular to the first and second dimensions, etc.

One may further code and decode a plurality of n-state data symbols by associating the data symbols with a first matrix. One may then generate check symbols over instances of a dimension (a row for instance). In order to enable decoding the data symbols and check symbols are then associated with a second matrix. It should be clear that the second matrix has more dimensions that the first matrix. Furthermore, one may create Reed Solomon codewords for the check symbols by creating check symbols for the check symbols (check-the check symbols).

While one may solve errors by using the symbols in errors as unknowns one may also solve the magnitude of an error by using syndromes.

As described above and by the inventor in U.S. patent application Ser. No. 11/680,719 filed Mar. 1, 2007 and in Ser. No. 11/739,189 filed Apr. 24, 2007 and in U.S. patent application Ser. No. 11/969,560 filed on Jan. 4, 2008, which are all incorporated herein by reference, one may create n-state check symbols by executing the n-state expression: s11→a*x1+b*x2+c*x3+d*x4 wherein + is an n-valued adder (be it mod-n or over GF(n)) and * is an n-valued multiplication. If one wants to solve the equation for unknowns the multiplication must be a reversible function. This means that the multiplication could be defined in the extension field GF(n=2^{p}) if n is a multiple of 2.

It was also shown earlier that an n-valued constant multiplier applied to an n-state variable may be treated as an n-valued inverter. Accordingly one may write the equation for s11 as:

s11>invₐ(x1)sc1 inv_{b}(x2) sc2 inv_{c}(x3) sc3 inv_{d}(x4).

Herein invₐ(x1) means that x1 is modified according to an inverter invₐ which is n-valued multiplication by a factor ‘a’.

It was shown by the inventor in U.S. Non-Provisional patent application Ser. No. 10/935,960, filed on Sep. 8, 2004 which is incorporated herein by reference how a function with inputs containing an inverter can be reduced to a function having no inverter. According to this aspect one could write s11 for instance as: s11→(((x1 scₘ1 x2) scₘ2 x3) scₘ3 x4). Herein a function scₘ is an n-valued function modified according to one or more inverters. For illustrative purposes functions over GF(2^{p}) will be used, as this make manipulation of expressions easier. However, other n-state functions are possible and are fully contemplated. Adders over GF(2^{p}) are associative, distributive and self reversing. As was shown above, solving equations can easily be achieved with for instance Cramer's rule. Because Cramer's rule will lead to adding of terms which are multiplied by a coefficient, one may in implementation reduce these functions again according to the inverters which represent the multipliers, to reduced functions not being an addition and not having multipliers, thus making execution of an n-valued expression faster.

It was also shown that in n-valued or n-state logic one may create from the same n-valued symbols two different and independent equations to generate a check symbol. For instance:

s11→a1*x1+b1*x2+c1*x3+d1*x4

s12→a2*x1+b2*x2+c2*x3+d2*x4

The above, and other n-state switching expressions provided herein, may look like arithmetical expressions. It is emphasized that these expressions are n-state switching or logic expressions that are to be implemented in devices.

One can thus create a codeword [x1 x2 x3 x4 s11 s12] which may be part of a code wherein each codeword differs at least in 3 symbols in like positions. This means that in such a code two errors can be detected in each codeword (without determining a location) by recalculating the check symbols. These errors may include errors in the check symbols. Codewords with such a property can be generated by LFSRs, but also by direct execution of the expressions as shown above. If one uses an LFSR such an LFSR may be in Galois or Fibonacci configuration. In general Galois configuration LFSRs are used in the literature, however this is not required and Fibonacci configurations may have a speed advantage as one may start generating check symbols directly. A Galois LFSR needs to read-in each symbol to generate the correct content of the shift register and then needs to read-out the generated symbols. LFSR methods are for instance used in CRC error detection. By using this type of codewords errors in case of two errors in a codeword cannot be hidden by canceling each other out under certain conditions.

For illustrative purposes the number of errors will not exceed 3 in a word. One may use a 4-valued or higher valued code to achieve the required number of independent equations to generate n-valued check symbols. While the selection of n does not affect the number of errors that can be detected with 100% certainty, it does affect the chance of hiding additional errors. Assume that a codeword has 5 n-valued symbols of which 2 are check symbols generated by independent equations. Assume further that 2 symbols are in error and can be detected. The chance that a third error in one of the other symbols will create a correct codeword is smaller as n becomes greater and the chance that an additional error is hiding becomes smaller.

For instance one may generate two 4-valued check symbols s1 and s2 by the following equations:

s1=x1+x2+x3; and

s2=x1+2*x2+3*x3,

wherein + and * are defined in GF(4).

There are 64 4-valued codewords [x1 x2 x3 s1 s2]. Assume 2 errors: e1 and e2 in the codeword for instance as: [e1 x2 e3 s1 s2].

In accordance with an aspect of the present invention a value of n is selected for creating codewords that will detect at least p errors and that increases the chance to detect p+1 errors.

As an example apply the 4-valued codeword [x1 x2 x3 s1 s2]=[0 0 3 3 2], wherein check symbols s1=3 and s2=2 are generated by the earlier provided independent expressions. Assume that symbols x2 and s2 are received correctly. This means that errors in x1, x3 and s1 must occur in such a way that a correct codeword will be formed. The correct codewords in this set of codewords with x2=0 and s2=2 are:

[1 0 1 0 2];
[2 0 0 2 2]; and
[3 0 2 1 2].

For an 8-valued code one may apply the expressions:

s1=x1+x2+x3; and

s2=x1+2*x2+7*x3,

wherein + and * are defined over GF(8).

Assume an 8-valued codeword [x1 x2 x3 s1 s2]=[1 7 4 6 3] wherein check symbols s1=6 and s2=3 are generated by the provided independent 8-valued expressions. Assume that symbols x2 and s2 are received correctly. This means that errors in x1, x3 and s1 must occur in such a way that a correct codeword will be formed. The correct codewords in this set of codewords with x2=7 and s2=3 are:

[0 7 1 3 3];
[2 7 7 2 3];
[3 7 2 4 3];
[4 7 6 1 3];
[5 7 5 7 3];
[6 7 3 5 3]; and
[7 7 0 0 3].

Accordingly it is less likely for an 8-valued codeword with 3 symbols in errors to generate a correct codeword than it is for errors in a 4-valued codeword to do the same. However it is probably fair to say that that for higher values of n it already is fairly unlikely to generate a correct codeword from errors.

This means that most likely an n-valued codeword with p check symbols over a first dimension with k n-valued symbols generated by p independent equations but with m instances of a second dimension in error with k>p, but wherein a second dimension with q check symbols over a second dimension has not more instances of the first dimension in error than p, one is likely able to solve q×m>p×q errors.

Assume the three check symbols over a data symbols [x1 x2 x3 x4] are determined by three independent n-valued expressions:

a1*x1+a2*x2+a3*x3+a4*x4=s1;

b1*x1+b2*x2+b3*x3+b4*x4=s2; and

c1*x1+c2*x2+c3*x3+c4*x4=s3.

For illustrative purposes assume ‘+’ to be an addition over GF(8) and ‘*’ be a multiplication over GF(8). Check symbols may be generated by either executing the above expressions by 8-valued switching functions, or by running an LFSR that will generate [r1 r2 r3], or by executing three 8-valued expressions in a 8-state switching device which are equivalent to the above expressions. It has been shown by the inventor in the earlier cited patent applications that expressions containing a multiplication by a constant and an addition may be reduced to a function not being an addition and containing not a multiplication. Such an equivalent expression may determine a check symbol faster than an expression containing an multiplication. It may be easier to first determine all expressions with multiplications and additions because in GF(8) these functions are commutative, associative and distributive, and reduce the obtained final expressions.

For solving the errors in a matrix wherein the number of potential errors is significantly smaller than the number of data symbols, it may be easier to apply syndrome calculations. In the above example one may assume that any of the five symbols in the first row can be in error. It is also assumed that the check symbols are known to be error free. One may also use the methods disclosed herein for check symbols that are not error free. However one then has to solve the equations for solving errors in check symbols, as in that case no fundamental difference can be made between data symbols and check symbols.

FIG. 7 shows a matrix code with 3 independent check symbols per column and per row. An error situation is shown in FIG. 7. After recalculation of check symbols it is clear that errors have occurred in rows 1, 2 and 5; and it is clear that errors have occurred in columns 1, 2, 3 and 4. Assume that the code is dimensioned in such a way that “illegal” errors which are more than 3 errors in a row or in a column have not occurred. In fact an error ‘eij’ is an assumed error, not an actual error. The actual errors are indicated as ‘aeij’ and are printed in bold and a larger font in FIG. 7. The positions of the actual errors are of course unknown a priori solving the errors. However the total assumed number of errors can all be resolved using the independent n-valued expressions.

Assuming that the check symbols are error free, one may then determine:

a1*(x1+e11)+a2*(x2+e12)+a3*(x3+e13)+a4*(x4+e14)=(s11+se11);

b1*(x1+e11)+b2*(x2+e12)+b3*(x3+e13)+b4*(x4+e14)=(s12+se12); and

c1*(x1+e11)+c2*(x2+e12)+c3*(x3+e13)+c4*(x4+e14)=(s13+se13).

Herein (x1+e11), (x2+e12), and (x1+e13) are the received values of the data symbols for the position of x1, x2 and x3. It may be assumed that the “error-free” value of a symbol was changed during transmission by a value ‘e’. By inputting these received values in the expressions one can determine the calculated check symbol values. These calculated check value symbols may differ from the received check value symbols by a factor ‘seij’. It was assumed that the received check symbols are error free (or can be made error free by applying a Reed Solomon code, using check symbols over check symbols). Accordingly one can determine what a difference between calculated and received data symbols is.

Because of the properties of the multiplication and addition function one may reduce the above expressions to the syndrome equations:

a1*e11+a2*e12+a3*e13+a4*e14=se11;

b1*e11+b2*e12+b3*e13+b4*e14=se12; and

c1*e11+c2*e12+c3*e13+c4*e14=se13.

Because of the spreading of the errors over all column positions, it is not possible to solve these column equations, as there are 4 unknowns and 3 equations. It should pointed out that if the error ‘ae11’ in FIG. 7 had not occurred one would be able to solve directly the syndrome equations for e11, e12 and e13 and create the correct value of x1, x2 and x3 by adding over GF(8) the value of the error to the received value. This is because e11+e11=0 over GF(8) and thus (x1+e11)+e11=x1+(e11+e11)=x1+0=x1.

However, one can also see from FIG. 7 that each column only will have 3 assumed syndrome errors (of which some will be 0), and these can be calculated directly by solving the set of equations for the syndromes, for instance by applying Cramer's rule.

A worked out 8-valued example will be provided next. Assume that the three check symbols over a row of 8-valued data symbols, as shown in FIG. 8 will be provided by the 8-valued expressions:

x1+x2+x3+x4=s1;

x1+2*x2+5*x3+2*x4=s2; and

x1+3*x2+4*x3+7*x4=s3.

Herein x1, x2, x3, and x4 are the consecutive data symbols in a row and the codeword formed by a matrix row is then [x1 x2 x3 x4 s1 s2 s3].

A similar approach can be applied to generating check symbols r1, r2 and r3 over each column of data symbols. To make a difference between data symbols ordered in a row or a column the column symbols will be designated as ‘yi’. The generating 8-valued expressions over GF(8) are then:

y1+y2+y3+y4+y5=r1;

y1+2*y2+3*y3+4*y4+5*y5=r2; and

y1+5*y2+7*y3+2*y4+3*y5=r3.

Please note that in the example a column has 5 data symbols and a row has 4 data symbols. Each row and each column have one symbol in common. It is assumed in FIGS. 7 and 8 for illustrative purposes that the check symbols are error free. Check symbols to check the check symbols may be assumed but are not shown and may be part of an RS code for check symbols.

The following matrix shows the received symbols of which some may be in error and the correct check symbols as calculated before being transmitted (d is a data symbol, c indicates a check symbol).

$$\begin{matrix}d & d & d & d & d & c & c & c \\ d & 1 & 2 & 3 & 0 & 0 & 0 & 0 \\ d & 1 & 2 & 3 & 4 & 0 & 6 & 4 \\ d & 3 & 3 & 3 & 3 & 0 & 1 & 6 \\ d & 5 & 5 & 5 & 5 & 0 & 3 & 1 \\ d & 7 & 7 & 2 & 3 & 0 & 5 & 3 \\ c & 5 & 5 & 5 & 5 & & & \\ c & 5 & 5 & 5 & 5 & & & \\ c & 1 & 1 & 1 & 1 & & & \end{matrix}$$

A similar matrix, but now with the re-calculated check symbols will generate:

$$\begin{matrix}d & d & d & d & d & c & c & c \\ d & 1 & 2 & 3 & 0 & 6 & 0 & 7 \\ d & 1 & 2 & 3 & 4 & 3 & 5 & 1 \\ d & 3 & 3 & 3 & 3 & 0 & 1 & 6 \\ d & 5 & 5 & 5 & 5 & 0 & 3 & 1 \\ d & 7 & 7 & 2 & 3 & 5 & 0 & 4 \\ c & 6 & 6 & 0 & 7 & & & \\ c & 6 & 2 & 6 & 3 & & & \\ c & 0 & 2 & 6 & 2 & & & \end{matrix}$$

Comparing the difference in check symbols one may conclude that rows 1, 2 and 5 and all columns are in error. Accordingly one may solve errors over the columns. The first column with correct check symbols is [1 1 3 5 7 5 5 1]. Symbols 1, 2 and 5 may be assumed in error as [e1 e2 e3]. The syndrome is [(6+5) (6+5) (0+1)] which is achieved by adding GF(8) the re-calculated and the correct check symbol and provides [1 1 1].

The syndrome equations are:

e1+e2+e3=1;

e1+2*e2+5*e3=1; and

e1+5*e2+3*y5=1.

As shown before one can for instance calculate [e1 e2 e5] by applying Cramer's rule. This will provide e1=1, e2=0 and e3=0. This means that y1=1+e1=1+1=0; y2=1+0=1; and y5=7+0=7.

One may apply this method to all columns, solve the errors and determine the true value of the data symbols.

One may also solve the second column next. This is shown in the following matrix with ‘correct’ check symbols.

$$\begin{matrix}d & d & d & d & d & c & c & c \\ d & 0 & 0 & 3 & 0 & 0 & 0 & 0 \\ d & 1 & 1 & 3 & 4 & 0 & 6 & 4 \\ d & 3 & 3 & 3 & 3 & 0 & 1 & 6 \\ d & 5 & 5 & 5 & 5 & 0 & 3 & 1 \\ d & 7 & 7 & 2 & 3 & 0 & 5 & 3 \\ c & 5 & 5 & 5 & 5 & & & \\ c & 5 & 5 & 5 & 5 & & & \\ c & 1 & 1 & 1 & 1 & & & \end{matrix}$$

The matrix with re-calculated check symbols is provided in the following matrix.

$$\begin{matrix}d & d & d & d & d & c & c & c \\ d & 0 & 0 & 3 & 0 & 3 & 7 & 6 \\ d & 1 & 1 & 3 & 4 & 6 & 0 & 5 \\ d & 3 & 3 & 3 & 3 & 0 & 1 & 6 \\ d & 5 & 5 & 5 & 5 & 0 & 3 & 1 \\ d & 7 & 7 & 2 & 3 & 5 & 0 & 4 \\ c & 5 & 5 & 0 & 7 & & & \\ c & 5 & 5 & 6 & 3 & & & \\ c & 1 & 1 & 6 & 2 & & & \end{matrix}$$

By comparing the two matrices one can tell that still rows 1, 2 and 5 are in error but now only column 3 and 4 are in error. One may make a decision to solve the errors over either the columns or over the rows. The rows each have two unknowns, while the columns each have 3 unknowns. While it does not make a big difference in this case, in other cases it may make a difference in computing time which approach one takes. Accordingly, in accordance with an aspect of the present invention it is determined if a column or a row has the fewest number of unknowns. Based on this determination, the errors in the column or row with the lowest number of errors are solved.

As an aspect of the present invention thus a method has been provided for error correcting coding and decoding of n-valued symbols in a matrix that has at least 2 dimensions, and wherein over a first dimension (for instance the rows) k independent check symbols are developed and over a second dimension (for instance the columns) p independent check symbols are developed. One may provide check symbols over check symbols to make sure that after reception the check symbols are error free. As long as the errors in a row do not exceed k and the number of rows with errors does not exceed p, one may be able to correct all errors.

One may exchange the role of columns and rows as an aspect of the present invention, wherein then the columns are assumed to have a maximum number of errors that will not be exceeded and wherein the check symbols over the rows will be used to solve errors in the columns.

In reasonable error conditions such a code may have better performance than for instance a Reed Solomon product code. It can solve errors fairly easily, by virtue of simple error location detection and simple calculation of error magnitude. If not too many errors occur one can use fewer check symbols than a word coded in RS mode, which of course applies twice as many check symbols. The advantage of the RS code is that if the condition of sufficient independent check symbols (assume 2*b) is met one may solve the maximum number of errors (b) for each codeword.

It should be clear that the method of error correction can error correct at least p×q symbols if one dimension of the matrix each instance has p check symbols and each instance of the second dimension has q check symbols. In many cases ‘s’ n-valued check symbols generated by independent sets of equations will detect more than ‘s’ errors. Assume that in a row of data symbols p symbols in error may always be detected. Assume that up to q symbols in error will be detected in a column. Assume that each row has p errors, but there will not be overlap between errors in different rows. One then has to solve p×q×q unknowns of which p×q are errors. However one can easily imagine that the other unknowns are also errors, which have been detected. In that case one may solve up to p×q×q errors in a deterministic way.

The coding/decoding method provided above has of course limitations in the number of errors that can be corrected. It is assumed that a dimension has no more errors than can be detected. Such a limitation may be reasonable for instance over the rows, if the sequence of symbols is transmitted as sub-sequent rows. However such a limitation is a disadvantage to the column structure of the matrix. For instance assume an 8 by 8 matrix of data symbols, wherein each row and column is provided with three independently generated check symbols. Assume that at most 3 symbols in error can occur in a row. The following matrix shows an example of how one may still correct errors when more than 3 rows are in error.

[chemical structure]

Assume that the check symbols are error free. Symbols in error are shown as ‘e’. The grey cells indicate that rows or columns contain errors. In the above example each row has no more than 3 errors. However 5 rows are in error. Fortunately all errors are aligned in the same three columns. Though errors may cancel each other out, it is likely that for 8-valued symbols the columns in errors may still be identified correctly. In that case one can of course easily correct the errors.

The following matrix shows how both in a column or a row not more than 3 errors occur.

[chemical structure]

Errors occur in overlapping positions. One could provide more check symbols per column to address this issue. This would actually be a good deal, as each additional check symbol would enable correcting an additional error in a column.

As will be shown one may also solve errors by making assumptions. The assumptions for illustrative purposes will be quite limiting, making quasi deterministic solutions possible. After demonstrating how to address the assumptions and constraints it should be clear that one can make much more relaxed assumptions, enabling to go through different more or less likely solutions. Like in solving LDPC codes one may create a more probabilistic iterative error correcting approach. For solving the errors one needs to establish the generating equations for the check symbols. This is a novel approach, as most known LFSR based methods work with generating polynomials over GF, rather than their generating n-valued equation.

If one has just barely exceeded the conditions for deterministic solving of errors one may try to solve one row or column by “guessing” or running through all possibilities. Just solving by “guessing” of a limited number of errors may change the error tableau in such a way that next one may solve the remaining errors in a deterministic way.

One assumption may be that at most 3 consecutive errors will ever occur. That means that if more rows are in error than consecutive errors can occur, then there is only partial overlap of errors in rows. In that case also not all rows have overlap. One may then solve the errors by making some further assumptions. For instance in the above error situation one may start with the assumption that in some cases the first 3 rows in errors do not overlap the bottom two rows in error and solve the equations based in error for 3 columns. For each 3 columns one may solve the errors in a column and recalculate the errors in rows and columns.

For instance the above error tableau has the situation:

Columns 1, 2, 3, 4, 5, 6 and 7 are in error; so are rows 1, 2, 4, 6 and 8. The number of rows in error is greater than the maximum number of errors per row. Accordingly there may be assumed a limited overlap of errors. Assume first that only rows 1, 2 and 4 are in error and rows 6 and 8 are not. In a next step solve errors for the first reach of columns in error, columns 1, 2 and 3.

[chemical structure]

When one solves the errors and recalculate the check symbols the following error tableau will occur:

[chemical structure]

The solved errors will be named s. Recalculating the check symbols over columns is unreliable, because of the assumption. However recalculation of check symbols over a row will show if one has caught all errors in a row. Accordingly, based on the assumption, one will have cleared the errors in the first rows and one may replace the received symbols with the recalculated symbols. Row 2 will remain in error because column 4 will remain in error. The same reasoning applies to row 4. One may then fill in the correct values for the errors in row 1, and recalculating the check symbols will create the following tableau:

[chemical structure]

One may make the next assumption rows 2, 4 and 6 being in error, as well as columns 2, 3 and 4. Most likely columns 2 and 3 may also be assumed to be error free due to the previous step. Solving the errors and computing the correct value allows comparison with the previous step to confirm the correct solution. This will lead to the following tableau:

[chemical structure]

The above tableau now allows for solving the remaining errors.

The iterative method as provided above can also be used wherein the role of columns and rows are exchanged.

It should be clear that the successful execution of the above iterations depends on making the right assumptions. Accordingly, it would be beneficial to have several assumptions available to calculate “assumed” errors. In accordance with another aspect of the present invention one implements on a processor several ‘assumption trees’ of possible errors situations and pursue the ones that clear (in this case) the row errors. One may also implement and/or execute each tree in a separate processor, thus enabling the processing of each tree in parallel. One may then execute each ‘tree’ and check if such a tree provides a solution. One may then select the solution of a tree that provides a clear and unambiguous solution. For instance the assumption that rows 1 and row 8 are error free for most of the columns will not clear the check symbols of the rows.

It should be clear that while in the above examples the check symbols are designed to be error free, this is not a necessary requirement for the herein provided error correcting methods to work. One may apply these methods also when check symbols can be in error. However in that case one may have to solve error situations wherein errors and solved errors are check symbols. Such methods are fully contemplated as an aspect of the present invention.

Furthermore, to solve errors, the syndromes are used to calculate the magnitude of the error and then calculate the correct value of the symbol in error. When it is known which symbols are in error and what the correct value of a check symbol is, one may also directly solve the value of a symbol in error. However in general this requires solving more equations and may take more time. There may be situations wherein solving more equations but not having to calculate the correct value from a symbol in error and an error magnitude is actually faster and such situations are fully contemplated as an aspect of the present invention.

As was shown above, one may create a matrix of 2 or more dimensions, with at least k columns and m rows of n-state data symbols, wherein each row has p check symbols, each check symbol being generated by applying one of p independent n-state expressions with the symbols in the row as variables, and each column has at least q check symbols, each of those check symbols being determined from m n-state data symbols in a column by using one of q independent n-state expressions with the m n-state data symbols as variables.

One may have several situations: p=q, p<q or q<p. In case p=q or q<p then the maximum number of unknowns that can be resolved in a matrix containing the data symbols and check symbols are at most p² data symbols in error. One would probably prefer to solve the equations with the fewest number of unknowns. However a p by p set of unknowns requires (at least initially) that the rows with p unknowns to be resolved. Once, one has resolved enough rows so that q rows with unknowns are left, one may proceed with solving equations with up to q unknowns determined by columns. It should be clear that the roles of columns and rows can be switched and q>p or that a column has more check symbols than a row. In that case up to q² unknowns can be resolved.

### Reduced Row-Echelon Form Solution

In a number of the cases wherein one may have for instance more rows in error than check symbols one may still have enough independent equations to solve the errors from the known syndromes. In such case the solutions may be overdetermined. One may be able to solve the equations by using the known Reduced Row-Echelon method, also known as the Gauss or Gauss-Jordan Echelon method. Herein, one reduces the matrix with the syndrome equations to the form wherein each row has just one independent solution. This approach is known and is for instance implemented in the mathematical software program Matlab as the instruction “rref(A)”, wherein A is the unreduced matrix with all equations. In general the Matlab instruction rref(A) applies common 10-valued arithmetic to all elements of the matrix to wipe the columns. It should be clear that one can adapt such a method to for instance modulo-10 arithmetic. One may adapt the rules also to any other arithmetic over GF(n), which is fully contemplated as an aspect of the present invention. One may also adapt the rule and implement it for error correction for any modulo-n or GF(n) arithmetic.

As an illustrative example the normal decimal instruction rref(A) in Matlab will be applied, with the understanding that the method can be adapted to any n-valued logic. The purpose is to show that in a number of cases a sufficient number of independent equations is available to solve the errors.

For instance assume the following 10-valued code matrix:

$$\begin{matrix} & 1 & 2 & 3 & 4 & 5 & r 1 & r 2 \\ 1 & & & & & & & \\ 2 & & & & & & & \\ 3 & & & & & & & \\ 4 & & & & & & & \\ 5 & & & & & & & \\ q 1 & & & & & & & \\ q 2 & & & & & & & \end{matrix}$$

In this code 25 10-valued data symbols are ordered in a 5 by 5 matrix. Each row and each column has two check symbols: r1 and r2 to each row and q1 and q2 to each column. The first check symbol of each row and each column is determined by r1=x1+x2+x3+x4+x5. Herein, + (for illustrative purposes) is the normal addition. This means that r1 can be multi-digit. In the GF(n) case the ‘+’ is a logic function which can be an addition over GF(n) such as modulo-n add if appropriate. In that case the check symbol will be a single symbol. As was shown above one can solve an equation for such a case.

The second symbol in this example is created by r2=x1+2x2+5x3+6x4+8×5. These equations apply to check symbols in columns as well as rows in the matrix. One can then calculate the check symbols for a specific set of data symbols. One can assure that all check symbols are error free, for instance by using a Reed Solomon code for the check symbols. As was explained before, one may also solve any error in a column or a row if one does not assure error free check symbols. This makes the code less efficient because one may have to solve non data symbol errors. However, this does not fundamentally change the approach.

Assume a following syndrome matrix, based on error free check symbols:

$$\begin{matrix} & 1 & 2 & 3 & 4 & 5 & r 1 & r 2 \\ 1 & e 1 & e 2 & & & & 2 & 3 \\ 2 & e 3 & e 4 & & & & 2 & 3 \\ 3 & e 5 & e 6 & & & & 2 & 3 \\ 4 & & & & & & & \\ 5 & & & & & & & \\ q 1 & 3 & 3 & & & & & \\ q 2 & 8 & 8 & & & & & \end{matrix}$$

From the syndromes it is clear that errors may have occurred in rows 1, 2 and 3 in columns 1 and 2. Potential errors can be e1, e2, e3, e4, e5 and e6. This exceeds the capabilities to solve the columns (as each column only has 2 equations but potentially 3 unknowns). One may solve of course the rows, as each row has two equations and two unknowns. One may also conclude that in total 6 unknowns may be present with 10 equations. Accordingly, the system of unknowns may be over-determined and can be solved by using Gauss-Jordan.

One can translate the above matrix to a matrix R wherein each row represents an equation with unknowns e1, e2, e3, e4, e5 and e6. The matrix is shown in the following table:

| e1 | e2 | e3 | e4 | e5 | e6 | check symbol |
|---|---|---|---|---|---|---|
| 1 | 1 | 0 | 0 | 0 | 0 | 2 |
| 1 | 2 | 0 | 0 | 0 | 0 | 3 |
| 0 | 0 | 1 | 1 | 0 | 0 | 2 |
| 0 | 0 | 1 | 2 | 0 | 0 | 3 |
| 0 | 0 | 0 | 0 | 1 | 1 | 2 |
| 0 | 0 | 0 | 0 | 1 | 2 | 3 |
| 1 | 0 | 1 | 0 | 1 | 0 | 3 |
| 1 | 0 | 2 | 0 | 5 | 0 | 8 |
| 0 | 1 | 0 | 1 | 0 | 1 | 3 |
| 0 | 1 | 0 | 2 | 0 | 5 | 8 |

Applying Gauss-Jordan to this matrix by Matlab's “rref(R)” will provide

$$\begin{matrix}e 1 & e 2 & e 3 & e 4 & e 5 & e 6 & r \\ 1 & 0 & 0 & 0 & 0 & 0 & 1 \\ 0 & 1 & 0 & 0 & 0 & 0 & 1 \\ 0 & 0 & 1 & 0 & 0 & 0 & 1 \\ 0 & 0 & 0 & 1 & 0 & 0 & 1 \\ 0 & 0 & 0 & 0 & 1 & 0 & 1 \\ 0 & 0 & 0 & 0 & 0 & 1 & 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0\end{matrix}$$

This provides the value 1 for each of the errors e1, e2, e3, e4, e5 and e6 which should be subtracted from the value of the received corresponding data symbols.

Unfortunately Gauss Jordan does not work directly on a situation wherein 3 rows and 3 columns appear to be in error. In such a case one presumably has potentially 3×3 or 9 errors, with 6+6=12 equations. However the set turns out to be underdetermined. One may check such situations by determining if a rank for Ax=0 and Ax+B=0 are identical.

One may assume that the rows will not exceed the maximum number of errors. By reducing the unknowns with just one makes the set of equations solvable. For instance one may have the error situation as provided in the following table

$$\begin{matrix} & 1 & 2 & 3 & 4 & 5 & r 1 & r 2 \\ 1 & e 1 & e 2 & e 3 & & & 2 & 3 \\ 2 & e 4 & e 5 & e 6 & & & 2 & 3 \\ 3 & e 7 & e 8 & e 9 & & & 2 & 7 \\ 4 & & & & & & & \\ 5 & & & & & & & \\ q 1 & 2 & 3 & 1 & & & & \\ q 2 & 3 & 8 & 5 & & & & \end{matrix}$$

The check symbols imply that there may be 9 errors. However, the error condition dictates that no more than 2 errors occur in a row. Accordingly at least one error is 0. For instance assume e3=0 and solve the 8 remaining errors with Gauss Jordan with for instance Matlab statement ‘rref(A)’. This set is solvable and provides the correct errors. Accordingly, one may develop an iterative scheme and assuming that one or more of the assumed errors are actually 0 and solving the remaining error equations. One may also add one or more check symbols to for instance a column which thus makes a set of equations solvable. A matrix suggests a symmetry wherein all columns (and all rows) have the same number of check symbols. However such symmetry is not required and one may add check symbols to any row or column.

In general, one connects a product code to a single matrix, wherein data symbols in each row or column determines a check symbol, which is also related to a row or a column. It was shown in U.S. patent application Ser. No. 11/680,719 filed on Mar. 1, 2007 and which is incorporated herein in its entirety that there are advantages to assign check symbols to data symbols that are not strictly assigned to a single column or row. Such an approach can be used to “unhide” data symbols that are correct or in error. From the above, it should be clear that there are situations wherein there may be sufficient check symbols to solve the actual errors, if only one can determine where they are located. Reed-Solomon codes provide the redundancy to solve up to k/2 symbols in error if one has k or k+1 check symbols. In many cases one does not want this overhead or redundancy.

In accordance with a further aspect of the present invention one may combine aspects as disclosed above with check symbols determined from data symbols that are not strictly in one column or one column of 1 matrix. The following illustrative example illustrates this approach.

Assume one has 16 n-state symbols arranged in a 4 by 4 matrix. A check symbol may be determined over each instance of a dimension (rows and columns). This is shown in the following table.

| | | | | |
|---|---|---|---|---|
| x11 | x12 | x13 | x14 | s1 |
| x21 | x22 | x23 | x24 | s2 |
| x31 | x32 | x33 | x34 | s3 |
| x41 | x42 | x43 | x44 | s4 |
| p1 | p2 | p3 | p4 | |

The symbols xij are the data symbols. The symbols si and pj are check symbols determined over rows and columns respectively. One may add check symbols for the check symbols, which may be assumed herein. Assume that one all check symbols are error free after reception. Assume also that x11, x22 and x33 are in error after transmission. This means that check s1, s2, s3, p 1, p2 and p3 will indicate an error. This means that one has potentially 9 errors or unknowns that have to be solved, which is not possible. One may determine 4 additional check symbols for error detection which are determined for instance as q1=F(x11, x22, x33, x44); q2=G(x12, x23, x34, x41); q3=H(x13, x24, x31, x42); and q4=I(x14, x21, x32, x43). The functions F, G, H and I may be different, they may also be identical. The following table shows the dependencies of check symbols:

| x11 | x12 | x13 | x14 | x21 | x22 | x23 | x24 | x31 | x32 | x33 | x34 | x41 | x42 | x43 | x44 | cs |
|---|---|---|---|---|---|---|---|---|---|---|---|---|---|---|---|---|
| 1 | 1 | 1 | 1 | 0 | 0 | 0 | 0 | 0 | 0 | 0 | 0 | 0 | 0 | 0 | 0 | e |
| 0 | 0 | 0 | 0 | 1 | 1 | 1 | 1 | 0 | 0 | 0 | 0 | 0 | 0 | 0 | 0 | e |
| 0 | 0 | 0 | 0 | 0 | 0 | 0 | 0 | 1 | 1 | 1 | 1 | 0 | 0 | 0 | 0 | e |
| 0 | 0 | 0 | 0 | 0 | 0 | 0 | 0 | 0 | 0 | 0 | 0 | 1 | 1 | 1 | 1 | |
| 1 | 0 | 0 | 0 | 1 | 0 | 0 | 0 | 1 | 0 | 0 | 0 | 1 | 0 | 0 | 0 | e |
| 0 | 1 | 0 | 0 | 0 | 1 | 0 | 0 | 0 | 1 | 0 | 0 | 0 | 1 | 0 | 0 | e |
| 0 | 0 | 1 | 0 | 0 | 0 | 1 | 0 | 0 | 0 | 1 | 0 | 0 | 0 | 1 | 0 | e |
| 0 | 0 | 0 | 1 | 0 | 0 | 0 | 1 | 0 | 0 | 0 | 1 | 0 | 0 | 0 | 1 | |
| 1 | 0 | 0 | 0 | 0 | 1 | 0 | 0 | 0 | 0 | 1 | 0 | 0 | 0 | 0 | 1 | e |
| 0 | 1 | 0 | 0 | 0 | 0 | 1 | 0 | 0 | 0 | 0 | 1 | 1 | 0 | 0 | 0 | G |
| 0 | 0 | 1 | 0 | 0 | 0 | 0 | 1 | 1 | 0 | 0 | 0 | 0 | 1 | 0 | 0 | H |
| 0 | 0 | 0 | 1 | 1 | 0 | 0 | 0 | 0 | 1 | 0 | 0 | 0 | 0 | 1 | 0 | I |

The column cs shows with an ‘e’ if the check symbol indicates an error. The check symbols indicated in the rows containing G, H and I may assumed to be error free. One may turn the ones in the rows indicated by ‘e’ in the columns of rows with G, H and I from a 1 into a 0. This is shown in the following table.

| x11 | x12 | x13 | x14 | x21 | x22 | x23 | x24 | x31 | x32 | x33 | x34 | x41 | x42 | x43 | x44 | cs |
|---|---|---|---|---|---|---|---|---|---|---|---|---|---|---|---|---|
| 1 | 0 | 0 | 0 | 0 | 0 | 0 | 0 | 0 | 0 | 0 | 0 | 0 | 0 | 0 | 0 | e |
| 0 | 0 | 0 | 0 | 0 | 1 | 0 | 0 | 0 | 0 | 0 | 0 | 0 | 0 | 0 | 0 | e |
| 0 | 0 | 0 | 0 | 0 | 0 | 0 | 0 | 0 | 0 | 1 | 0 | 0 | 0 | 0 | 0 | e |
| 0 | 0 | 0 | 0 | 0 | 0 | 0 | 0 | 0 | 0 | 0 | 0 | 1 | 1 | 1 | 1 | |
| 1 | 0 | 0 | 0 | 0 | 0 | 0 | 0 | 0 | 0 | 0 | 0 | 0 | 0 | 0 | 0 | e |
| 0 | 0 | 0 | 0 | 0 | 1 | 0 | 0 | 0 | 0 | 0 | 0 | 0 | 0 | 0 | 0 | e |
| 0 | 0 | 0 | 0 | 0 | 0 | 0 | 0 | 0 | 0 | 1 | 0 | 0 | 0 | 0 | 0 | e |
| 0 | 0 | 0 | 0 | 0 | 0 | 0 | 0 | 0 | 0 | 0 | 0 | 0 | 0 | 0 | 1 | |
| 1 | 0 | 0 | 0 | 0 | 1 | 0 | 0 | 0 | 0 | 1 | 0 | 0 | 0 | 0 | 1 | e |
| 0 | 1 | 0 | 0 | 0 | 0 | 1 | 0 | 0 | 0 | 0 | 1 | 1 | 0 | 0 | 0 | G |
| 0 | 0 | 1 | 0 | 0 | 0 | 0 | 1 | 1 | 0 | 0 | 0 | 0 | 1 | 0 | 0 | H |
| 0 | 0 | 0 | 1 | 1 | 0 | 0 | 0 | 0 | 1 | 0 | 0 | 0 | 0 | 1 | 0 | I |

The above process of changes 1 has been highlighted by making the 0s bold and underlined. One can now read from the first three rows which symbols are in error: x11, x22 and x33, indicated by the 1s. By using the expressions to determine the check symbols in reverse one may solve the errors.

One may provide a more elaborate example by also making x12 in error. This will lead to the following table:

| x11 | x12 | x13 | x14 | x21 | x22 | x23 | x24 | x31 | x32 | x33 | x34 | x41 | x42 | x43 | x44 | cs |
|---|---|---|---|---|---|---|---|---|---|---|---|---|---|---|---|---|
| 1 | 1 | 1 | 1 | 0 | 0 | 0 | 0 | 0 | 0 | 0 | 0 | 0 | 0 | 0 | 0 | e |
| 0 | 0 | 0 | 0 | 1 | 1 | 1 | 1 | 0 | 0 | 0 | 0 | 0 | 0 | 0 | 0 | e |
| 0 | 0 | 0 | 0 | 0 | 0 | 0 | 0 | 1 | 1 | 1 | 1 | 0 | 0 | 0 | 0 | e |
| 0 | 0 | 0 | 0 | 0 | 0 | 0 | 0 | 0 | 0 | 0 | 0 | 1 | 1 | 1 | 1 | |
| 1 | 0 | 0 | 0 | 1 | 0 | 0 | 0 | 1 | 0 | 0 | 0 | 1 | 0 | 0 | 0 | e |
| 0 | 1 | 0 | 0 | 0 | 1 | 0 | 0 | 0 | 1 | 0 | 0 | 0 | 1 | 0 | 0 | e |
| 0 | 0 | 1 | 0 | 0 | 0 | 1 | 0 | 0 | 0 | 1 | 0 | 0 | 0 | 1 | 0 | e |
| 0 | 0 | 0 | 1 | 0 | 0 | 0 | 1 | 0 | 0 | 0 | 1 | 0 | 0 | 0 | 1 | |
| 1 | 0 | 0 | 0 | 0 | 1 | 0 | 0 | 0 | 0 | 1 | 0 | 0 | 0 | 0 | 1 | e |
| 0 | 1 | 0 | 0 | 0 | 0 | 1 | 0 | 0 | 0 | 0 | 1 | 1 | 0 | 0 | 0 | e |
| 0 | 0 | 1 | 0 | 0 | 0 | 0 | 1 | 1 | 0 | 0 | 0 | 0 | 1 | 0 | 0 | H |
| 0 | 0 | 0 | 1 | 1 | 0 | 0 | 0 | 0 | 1 | 0 | 0 | 0 | 0 | 1 | 0 | I |

Applying the above technique will lead to:

| x11 | x12 | x13 | x14 | x21 | x22 | x23 | x24 | x31 | x32 | x33 | x34 | x41 | x42 | x43 | x44 | cs |
|---|---|---|---|---|---|---|---|---|---|---|---|---|---|---|---|---|
| 1 | 1 | 0 | 0 | 0 | 0 | 0 | 0 | 0 | 0 | 0 | 0 | 0 | 0 | 0 | 0 | e |
| 0 | 0 | 0 | 0 | 0 | 1 | 1 | 0 | 0 | 0 | 0 | 0 | 0 | 0 | 0 | 0 | e |
| 0 | 0 | 0 | 0 | 0 | 0 | 0 | 0 | 0 | 0 | 1 | 0 | 0 | 0 | 0 | 0 | e |
| 0 | 0 | 0 | 0 | 0 | 0 | 0 | 0 | 0 | 0 | 0 | 0 | 1 | 1 | 1 | 1 | |
| 1 | 0 | 0 | 0 | 0 | 0 | 0 | 0 | 0 | 0 | 0 | 0 | 0 | 0 | 0 | 0 | e |
| 0 | 1 | 0 | 0 | 0 | 1 | 0 | 0 | 0 | 1 | 0 | 0 | 0 | 1 | 0 | 0 | e |
| 0 | 0 | 0 | 0 | 0 | 0 | 1 | 0 | 0 | 0 | 1 | 0 | 0 | 0 | 1 | 0 | e |
| 0 | 0 | 0 | 1 | 0 | 0 | 0 | 0 | 0 | 0 | 0 | 1 | 0 | 0 | 0 | 1 | |
| 1 | 0 | 0 | 0 | 0 | 1 | 0 | 0 | 0 | 0 | 1 | 0 | 0 | 0 | 0 | 1 | e |
| 0 | 1 | 0 | 0 | 0 | 0 | 1 | 0 | 0 | 0 | 0 | 1 | 1 | 0 | 0 | 0 | e |
| 0 | 0 | 1 | 0 | 0 | 0 | 0 | 1 | 1 | 0 | 0 | 0 | 0 | 1 | 0 | 0 | H |
| 0 | 0 | 0 | 1 | 1 | 0 | 0 | 0 | 0 | 1 | 0 | 0 | 0 | 0 | 1 | 0 | I |

One should project all the ones in rows that are known to be correct as 0 into the rows assumed to be in error. The above table suggests that x11, x12, x22, x23, and x33 may be in error. There are several ways to solve the errors. The simplest way is to clean up iteratively by first determining which row or column has only one error (column 1). Solve x11 in this column. Now row 1 has only one error, so solve x12. Now column 2 has only one error, so solve x22. Now row 2 has only one error, solve x23. Finally solve x33. Other approaches are also possible. For instance one may recalculate the check symbols every time an error has been resolved. There are sufficient equations to solve the unknowns (even if the unknowns are not in error). One may solve a set of equations to determine all unknowns.

The above example shows only the dependency of check symbols with the re-arranged n-state symbols in a matrix. The number of n-state-symbols in the first and the second matrix are preferably the same. Strictly speaking, that requirement is not absolutely necessary. For instance, one may use a second matrix for errors only occurring in the start of the rows of the first matrix. In the example, the check symbols in the second matrix are used for error detection. It should be clear that one can arrange a second matrix and create r≧different and independent check symbols per row or column. One may then use the expressions that are used to generate the check symbols to create systems of equations with the expressions of the first matrix to resolve errors. One may also create a different third matrix along the lines of the second matrix but with different jumps in index to unhide hidden errors.

All steps to resolve the errors in a decoder are deterministic, though they can be iterative, by cleaning errors from a row or column in a matrix that has a number of errors that is not greater than the number of check symbols associated with a row or a column. After an error has been resolved in a row of a matrix, it also diminishes the number of errors in the corresponding column of the matrix. This may put the total number of errors in a column in a condition of being equal or smaller than the related number of check symbols, which makes all errors in that column solvable. It also may be the case that by solving an error in a row of a first matrix, the numbers of errors in a row or a column in a related second matrix have become such that the errors have become solvable. It should be clear that while the above approach is illustrated by using errors in a row, it applies to solving errors in a column or in any other dimension in a k-dimensional matrix.

The selection of the size of a matrix depends among other aspects on the expected number of errors, and if errors are expected to appear in bursts or completely random. Errors may also be introduced deliberately.

The above approach works well with random errors and adjacent errors. Especially when n-state symbols are transmitted as binary words, it is possible that burst errors will affect at least two adjacent n-state symbols or words.

It should be understood that a matrix code is a virtual matrix made up from data symbols and calculated check symbols. In general symbols will not be transmitted as a matrix, but for instance sequentially in a frame of symbols. At the receiving end the virtual matrix can be reconstructed by assigning each symbol in a frame a position in the virtual matrix, which may for instance be stored in an addressable electronic memory.

In accordance with a further aspect of the present invention, the here provided methods and apparatus for error correction by error detection and symbol reconstruction can be used in a system, such as a communication system. A communication system may be a wired system or a wireless system. Such a system may be used for data transmission, telephony, video or any other type of transfer of information. A diagram of such a system is provided in FIG. 9. Herein 901 is a source of information. The information is provided to a coder 902. The information provided to a coder 902 may already be in a digital form. It may also be converted into digital form by the coder 902. The coder 902 creates the code words of a plurality of data symbols with added check symbols as described herein as another aspect of the present invention. The codewords are organized in such a way that up to a number of symbols in error can be identified as such. The thus created codewords may be provided directly to a medium 903 for transmission. They may also be provided to a modulator/transmitter 906 that will modify the digital coded signal provided by 902 to a form that is appropriate for the medium 903. For instance, 906 may create an optical signal, which may be written on an optical disk, or provided to a transmission medium such as an optical fiber. Modulator 906 may also be a radio transmitter, which will modulate the signal on for instance a carrier signal, and wherein 903 is a radio connection. Not specifically shown, but assumed, is circuitry as known to one of ordinary skill in the art to provide and insert “housekeeping” signals, which may include synchronization signals or other signals to assist a receiver to receive, demodulate, decode and display a signal.

At the receiving side a receiver 907 may receive, amplify, and demodulate the signal coming from 903 and provide a digital signal to a decoder 904. The decoder 904 identifies if and which symbols are in error in accordance with another aspect of the present invention and then applies the methods provided herein to correct symbols in error. A decoded and error corrected signal is then provided to a target 905. Such a target may be a radio, a phone, a computer, a tv set or any other device that can be a target for an information signal. A coder 902 may also provide additional coding means, for instance to form a concatenated or combined code. In that case, the decoder 904 has equivalent means to decode the additional coding. Additional information, such as synchronization, frame or ID information, may be inserted during the transmission and/or coding process.

In accordance with another aspect of the present invention, the here provided methods and apparatus for error correcting coding and decoding of signals can also be applied for systems and apparatus for storage of information. For instance, data stored on a CD, a DVD, a magnetic tape or disk or in mass memory in general may benefit from error correcting coding. A system for storing error correcting symbols in accordance with another aspect of the present invention is shown in diagram in FIG. 10. A source 1001 provides the information to be coded. This may be audio, video or any information data. The data may already be presented in n-valued symbols by 1001 or may be coded in such a form by 1002. Unit 1002 also creates the code words of a plurality of data symbols with added check symbols as described herein as another aspect of the present invention. Codewords are organized in such a way that up to a number of symbols in error can be identified as such. The thus created codewords may be provided directly to a channel 1004 for transmission to an information carrier 1005. In general, a modulator/data writer 1003 will be required to write a signal to a carrier 1005. For instance the channel requires optical signals or it may require magnetic or electro-magnetic or electro-optical signals. Modulator/data writer 1003 will create a signal that can be written via channel 1004 to a carrier 1005. Important additional information such as for ID and/or synchronization may be added to the data.

Accordingly, apparatus and methods for error detection and error correction as provided herein may be part of an audio player, a video player, a communication device, a storage device or any other device or system that may benefit from correction of errors in a signal. For instance it may be part or implemented in a mobile computing device such as a mobile phone or a personal digital assistant (PDA). It may also be part of a computer. It may also be part of any computing device that is enabled to receive and exchange data, either through a network or via a storage medium. A storage medium may be an optical disk, a magnetic disk or an electronic medium. Such media may store binary symbols and store n-state symbols as binary words such as bytes. It may also store n-state symbols as multi-state symbols, each symbol having one of 3 or more states. A computing device implementing one or more of the methods and/or n-state expressions may be connected to a network. Such a network may be a wired or a wireless network. The network may be the Internet. It may also be a single connection to another apparatus. Communication may take place with binary symbols, analog signals or signals being a multi-state symbol having one of 3 or more states, such as 16-QAM signals or any other signal that can have one of 3 or more states. A signal may be an electronic signal, a radio signal, an optical signal, an acoustical signal, a mechanical signal, a quantum mechanical signal, a chemical or bio-chemical signal that is able to transmit a symbol having one of 3 or more states.

FIG. 11 shows a diagram for error correcting decoding information read from a carrier 1105. The information is read through a channel 1104 (such as an optical channel or magnetic or electro-magnetic or electro-optical) and provided in general to a detector 1103 that will receive and may amplify and or demodulate the signal. The signal is provided to a decoder 1102 where error detection and error correction takes place. The information signal, possibly readied for presentation as an audio or video signal or any other form, is then provided to a target. The target may be a video screen, a computer, a radio or any other device that can use the decoded signal.

Not shown, but assumed, in all applications may be circuitry that performs housekeeping tasks such as synchronization, equalization, amplification, filtering, D/A and A/D conversion and the like to facilitate the processing of a signal.

The methods of error detection and error correction can be implemented in accordance with an aspect of the present invention in an apparatus that can perform the steps of the methods. The implementation can take place in a program with instructions that can be stored in a memory and that can be retrieved by a processor for execution. One may also implement the methods in accordance with an aspect of the present invention in dedicated hardware that will perform the steps of the methods. Such hardware may comprise custom designed circuitry. Such circuitry may be n-state circuitry that implements at least one of the n-state switching functions that is used in either determining a check symbol or to detect or to correct a symbol in error. Such hardware may also comprise programmable units that can be programmed to perform a certain function such as Field Programmable Gate Arrays. Instructions may also be implemented in binary logic circuitry, combined with Analog/Digital conversion circuitry to convert an n-state signal into a binary signal; or with Digital/Analog converter circuitry to convert a binary signal into an n-state signal.

One may represent an n-state symbol by an n-state signal with n>2. Such an n-state signal may be an n-level signal, wherein a state may be represented by one of n voltage levels or intensity levels with n greater than 2. One may also represent an n-state symbol with a signal that can assume one of n states which are linear independent, so that linear addition of 2 or more n-state signals will not create another n-state signal with n greater than 2. One may also represent an n-state symbol by a plurality of p-state symbols with p<n. One may also consider a plurality of binary signals to represent an n-state symbol. One may process an n-state symbol by a processor implementing an n-state switching function which may be represented by at least an n by n truth table. One may also process a plurality of binary signals as representing an n-state symbol by a binary processor, wherein the binary processor processes the plurality of binary symbols by a binary implementation of an n-state logic function in binary form and wherein the n-state logic function can be represented by at least an n-by-n truth table with n>2.

As an example one may process a plurality of binary signals as if 3 binary signals represent for instance an 8-state symbol. One may then process binary words wherein each word is formed by 3 bits by an implementation of an 8-state switching function. Such a function may be for instance the following function sc8 which is provided in 8-state notation and in binary notation as sc8b.

| sc8 | 0 | 1 | 2 | 3 | 4 | 5 | 6 | 7 | sc8b | 000 | 001 | 010 | 011 | 100 | 101 | 110 | 111 |
|---|---|---|---|---|---|---|---|---|---|---|---|---|---|---|---|---|---|
| 0 | 0 | 1 | 2 | 3 | 4 | 5 | 6 | 7 | 000 | 000 | 001 | 010 | 011 | 100 | 101 | 110 | 111 |
| 1 | 1 | 0 | 3 | 2 | 5 | 4 | 7 | 6 | 001 | 001 | 000 | 011 | 010 | 101 | 100 | 111 | 110 |
| 2 | 2 | 3 | 0 | 1 | 6 | 7 | 4 | 5 | 010 | 010 | 011 | 000 | 001 | 110 | 111 | 100 | 101 |
| 3 | 3 | 2 | 1 | 0 | 7 | 6 | 5 | 4 | 011 | 011 | 010 | 001 | 000 | 111 | 110 | 101 | 100 |
| 4 | 4 | 5 | 6 | 7 | 0 | 1 | 2 | 3 | 100 | 100 | 101 | 110 | 111 | 000 | 001 | 010 | 011 |
| 5 | 5 | 4 | 7 | 6 | 1 | 0 | 3 | 2 | 101 | 101 | 100 | 111 | 110 | 001 | 000 | 011 | 010 |
| 6 | 6 | 7 | 4 | 5 | 2 | 3 | 0 | 1 | 110 | 110 | 111 | 100 | 101 | 010 | 011 | 000 | 001 |
| 7 | 7 | 6 | 5 | 4 | 3 | 2 | 1 | 0 | 111 | 111 | 110 | 101 | 100 | 011 | 010 | 001 | 000 |

FIG. 12 shows an n-state implementation 1200 of function sc8, having an input 1202 and 1203, each enabled to receive an 8-state signal and an output 1204 that can provide an 8-state signal in accordance with the truth table of sc8. The implementation of the function sc8 may be based on components as disclosed in U.S. Pat. No. 7,218,144 issued on May 15, 2007, or with U.S. patent application Ser. No. 11/964,507 filed on Dec. 26, 2007, which are both incorporated herein by reference in their entirety. FIG. 12 also shows a binary implementation of the truth table sc8b, which is equivalent to sc8. An 8-state symbol herein may be provided as a word of 3 parallel bits on a set of 3 inputs 1205 and 1206. An 8-state symbol is then provided in accordance with the truth table of sc8b on the set of 3 outputs 1207. The binary implementation of sc8b can be 3 parallel devices implementing an XOR function. One can easily check that the output word of sc8b is created by taken the XOR of the 3 bits of a first word provided on input 1205 with the 3 bits of binary word provided on 1206.

A further possible implementation of the truth table of sc8b is shown 13, wherein an addressable binary storage memory 1300 is used. It applies an address decoder 1303, which is provided on 2 sets of 3 inputs 1301 and 1302 with 2 binary words of 3 bits. Based on the inputted 6 bits the address decoder enables a corresponding address line 1304, which enables the reading of a content of a memory 1305. This content is provided on the output set 1306 of 3 outputs. The relation between the input address and the binary output of the device of FIG. 13 is provided by the truth table of sc83.

In accordance with a further aspect of the present invention all multi-state symbols may be represented and processed in binary form as a plurality of binary symbols. It should be clear that in such a situation one should apply means to synchronize all symbols in accordance with the symbols they represent. One may also use multi-state symbols during part of a process and binary or other representation and processing during a different stage of processing. As an example it is known to use multi-state symbols for transmission of symbols. One may, if so desired, prepare and process the multi-state symbols in for instance binary form before actual transmission.

The present invention may be used in the detection and correction of errors that may have occurred after coding, but before decoding, for instance during but not limited to the transmission of symbols or signals. Errors may be caused by noise superimposed on a transmitted signal that was attenuated in strength during transmission. It is well known that the correction and/or detection of errors in signals before further processing is useful. It may prevent extraction and use of information that is no longer correct due to errors. It may prevent inaccurate playing of audio and/or video signals, which may be experienced by a user as noise or a nuisance. It may make possible the use of noisy and/or a scarce transmission medium such as a radio spectrum. Failure to correct errors may make use of a medium impossible. Accordingly, error correction is desirable and useful. Error correction requires redundancy in a signal. The ability to correct more errors with the same number of check symbols as in known and earlier applied methods is very advantageous, as it improves the use of spectrum and bandwidth. What one does is exchanging processing capability with bandwidth or number of users.

In a further embodiment of the present invention one may introduce deliberate errors in a signal as an annoyance or a security factor. In a further embodiment one may introduce errors at a rate that affects the quality of the use of received symbols or signals. Deliberate errors may be introduced at known positions in a frame of symbols, and may be considered erasures. In such situations, one knows at sending where errors are located. Information on where errors are located may be based on a predetermined scheme of which a receiving apparatus is aware or is made aware by an authority or by a signal.

In accordance with a further aspect of the present invention, errors may be deliberately introduced at known positions in a sequence of symbols, or errors may be introduced at random in a sequence of symbols. If errors are introduced at random, the number of errors that is introduced should be within the number of errors that can be solved by an error correction scheme. For instance, one may introduce errors deliberately that may be resolved by a Reed Solomon error correcting scheme. It is noted that RS codes are able to resolve a number of errors that is about half of the number of related check symbols. Furthermore, RS solving schemes are generally known. For error introduction to be effective, by requiring a specific and unique error correction approach, one may generate check symbols in a unique way that is not generally known. Otherwise, a normal RS error correcting scheme may be applied to solve the nuisance errors, thus rendering the nuisance errors ineffective. Unique methods and apparatus for generating RS-like codes and check symbols, are disclosed by the inventor in U.S. patent application Ser. No. 11/739,189 filed on Apr. 24, 2007; U.S. patent application Ser. No. 11/775,963 filed on Jul. 11, 2007; U.S. patent application Ser. No. 11/743,893 filed on May 3, 2007; and U.S. patent application Ser. No. 11/969,560 filed on Jan. 4, 2008 which are all four incorporated herein by reference in their entirety.

In accordance with an aspect of the present invention, a receiving apparatus thus is able to identify a position of a symbol deliberately put in error without requiring the application of check symbols. Information on a position of an n-state symbol deliberately put in error may be part of a receiving apparatus; it may be embedded in an apparatus, for instance as instructions in a program that can be executed by the receiving apparatus or it may be stored as data in a memory that can be read and processed by the receiving apparatus. A receiving apparatus may also be provided with the means to identify symbols that have been put deliberately in error, for instance by receiving and processing a signal, or by reading specific data to that effect from a storage medium, such as an optical disk, a memory or a magnetic disk or tape, or any other known storage medium. Such information may also be provided to a receiving apparatus via a network. Such network may be the Internet or via any other connection that allows a receiving apparatus to receive information related to symbols deliberately put in error.

For instance, one may have a playing apparatus, such as an audio player or a video player for playing an audio or video program that is played by processing a stream of digital signals. The stream of digital symbols may contain a plurality of symbols that is put deliberately in error. Such programs may still be playable, but may contain interference or noise-like features or other error like effects that diminish the quality of the displayed program. In a first embodiment, a player may be provided with information about the position of symbols in error. In a further embodiment, the player may be provided with means to use the information about the position of errors to minimize the effect of the deliberate errors. For instance a sender or originator of the deliberate errors may make an error by providing a symbol a state that represents the maximum intensity of a sound or a pixel. A receiver, knowing where the symbols in error are, may provide the symbols in error with a state that represents their lowest value. This does not eliminate the error, but may diminish its effect. In a further embodiment, one may also apply a program that interpolates a value for a symbol in error, based on preceding and succeeding symbols that are not in error. This may help to overcome all or part of the errors.

In a further embodiment, the deliberate errors may be put in a transmitted and to be received signal, so that they form a burst error in the displayed signal. Signals that are provided on Compact Disc or on DVD for instance, but also on transmitted signals, may be interleaved. Burst errors in a received signal or in a signal that is read from a storage medium is spread over different frames or displayed signals after de-interleaving. By positioning errors in a burst at pre-interleaving, one may enhance the annoyance effect that is difficult to overcome by interpolation measures.

In a further embodiment, one may provide a receiving or displaying apparatus with data or information, which may include instructions or rules for determining the check symbols, that allows the receiving apparatus or player to correct the symbols that were put deliberately in error, using also the position information on those errors. The correct decoding and/or position information of errors may be provided to an apparatus as a separate signal or as part of a signal containing the program to be displayed. Such data may be provided over a network such as the Internet or over a wireless network or via any other communication connection that can be used to transmit data. That data may also be embedded on a storage medium. Such information or data may be made available in such a way that only authorized players or apparatus may use it to correct deliberately introduced errors.

In yet a further embodiment one may provide errors deliberately in known positions by processing the correct symbol with a known symbol by using a reversible n-state switching function. One embodiment, using reversible n-state switching functions and known n-state symbols, is disclosed in U.S. patent application Ser. No. 10/912,954 filed on Aug. 6, 2004 and Ser. No. 12/264,728, filed on Nov. 4, 2008 which are both incorporated herein by reference in their entirety. These applications apply self reversing n-state switching functions. It should be clear that any reversible n-state switching function may be applied to modify (or scramble) a symbol in a known position. It is pointed out that scrambling is different from introducing errors. For correcting errors, one requires redundancy, such as providing check symbols. Descrambling does not require redundancy with check symbols, if one knows which symbols have been scrambled. However, for descrambling one requires at the receiving end information which symbols were scrambled, what the known symbols are against which the symbols were scrambled and the reversible function(s) that were applied to change the symbols. Cryptanalysis, including statistical analysis, may be applied to find the appropriate n-state functions and the “known symbols”. In a further embodiment, one may use a scrambler to provide errors to symbols in known positions, but apply error correction using check symbols as for instance provided herein or in any of the references incorporated herein by reference to correct those errors.

For security or other reasons a signal may be scrambled, thus preventing playing of the signal on for instance an audio or video display if an appropriate descrambler is not applied. In general, a complete signal is scrambled, thus preventing the complete display of the signal. It would be beneficial to scramble only part of the signal. This would allow a user to evaluate the content of the signal, for instance for purchasing it. One may for instance scramble part of a video program in such a way that one may view part of a screen, or for instance one may view a screen at a much lower than optimal quality.

For instance, one may apply an error ratio that affects the quality of an audio and/or video signal during display if errors are not corrected. One may apply an error ratio of correctable errors that makes display of these signals as an audio or video signal unusable. In a further embodiment, one may introduce correctable errors at a rate at which one can display a video or play an audio signal and discern the content of an image or a sound, however at a quality which can be improved discernibly by correcting the errors. In a further embodiment one may also introduce errors into a signal at a known rate without including check symbols. In one embodiment, one may introduce errors in symbols in known positions in a frame of symbols. One may calculate and include check symbols using implementable binary or n-state expressions that allow a receiver to detect or correct the errors.

In a further embodiment one may keep the expressions required to correct errors secret for a receiver. In a further embodiment, one may provide a receiver with instructions to be implemented in a processor to detect and/or correct symbols in error.

One may create a signal having a first part and a second part, wherein the first part does not have errors introduced and the second part has errors introduced. One may provide a signal that has deliberate errors introduced with check symbols that allow the detection and or correction of these errors at a receiver.

In a first embodiment one may introduce errors in data symbols after check symbols have been calculated. If the errors are detectable and correctable, a receiver with the appropriate error correcting apparatus may correct the errors, providing a full quality signal. In another embodiment one may withhold the error correction means from a receiver. By placing errors in data symbols that are not correctible one may create a deteriorated signal that still has sufficient quality, but a lower quality than what is optimally possible. A user may for instance purchase the appropriate error correction means, in either downloadable code via a network, or on a storage medium and install it on a processor in a receiver so that all introduced errors can be corrected, thus providing an optimal quality signal.

In one aspect of the present invention two or more sets of two or more n-state equations having two or more unknowns have to be resolved, for instance as it relates to solving errors in two or more rows or two or more columns of a matrix having at least two dimensions. One may solve the set of equations serially. In many cases there is a time constraint of the solving of errors, for instance in real time display of signals such as digital video signals. The time available for solving errors is then determined by the constraints imposed by the Nyquist-Shannon sampling theorem. In such a case it may be beneficial to have a separate and/or dedicated processor for solving a set of equations to solve one or more unknowns in a row or a column of n-state data symbols. Each set of equations is thus solved in parallel to others by a processor that implements at least one n-state logic function defined by at least an n by n truth table.

As stated above a processor may be a general processor or a Digital Signal Processor (DSP). A processor may also be dedicated hardware that is hardwired to execute the steps or instructions that are aspects of the present invention. Retrieving instructions thus may mean retrieving instructions from a memory and for instance to be put in an instruction register of a processor to be executed. Retrieving instructions in a hard-wired circuit, in the context of this application, may mean starting execution at a first circuit and forcing signals to go through a pre-determined series of circuits. The memory is thus a hardwired memory (hard-wired by connections in and/or between circuits) and retrieving and executing an instruction is moving of a signal from a previous circuit to a next circuit as is determined by the connections.

As described above, a sequence of n-state symbols, divided in blocks of a plurality of n-state symbols, signal is intentionally corrupted by modifying, in a reversible manner, at least one n-state symbol by applying an n-state switching function, which is preferably a reversible n-state switching function. A solution how to reverse the intentionally corrupted n-state symbols is in one embodiment of the present invention provided separately from the sequence of n-state symbols. Without such a solution one only has access to the corrupted sequence.

Preferably, the sequence is part of or constitutes a file such as an audio-file, a picture file, an image file, an audio-visual file or any file that can be received and displayed as an audio signal for instance through a loudspeaker or as a visual signal displayed on a display or an audio-visual file. The file may also be a data file, such as a financial file, or any other data file.

As described above, a sequence of n-state symbols, divided in blocks of a plurality of n-state symbols, signal is intentionally corrupted by modifying, in a reversible manner, at least one n-state symbol by applying an n-state switching function, which is preferably a reversible n-state switching function. A solution how to reverse the intentionally corrupted n-state symbols is in one embodiment of the present invention provided separately from the sequence of n-state symbols. Without such a solution one only has access to the corrupted sequence.

The term corrupted is applied herein. It is intended to mean modified. A sequence of symbols is to be corrupted or modified, if no further details are provided. In accordance with an aspect of the present invention, different manners or embodiments of corruption or modification are provided. In a first embodiment of the present invention there is random appearing corruption or modification. That is, it appears that a symbol in a sequence of symbols is apparently randomly modified. Or in other terms, a distribution of modified symbols in a sequence of symbols, which appears to have a level of coherence, appears to be random. The term random herein, is intended to mean pseudo-random or random-like, without further specification. However, true random modifications, based on an unrepeatable process are also provided herein, but should be specifically be identified. A pseudo-random process herein is assumed to be repeatable.

In a further embodiment of the present invention, a modification of a sequence of symbols is at least partially non-random or deterministic. This means that a block of symbols in the sequence of symbols is modified beyond a number of symbols determined by a pseudo-random mask. Such a block may form a plurality of samples in a digital representation of an audio signals or a block of pixels in an image or a plurality of symbols in a text or data file that is modified or corrupted.

In a further embodiment of the present invention a corruption or modification is reversible. In yet a further embodiment of the present invention a modification or corruption is irreversible in a deterministic sense. Modifying a corrupted symbol to its original state is called de-corruption herein. Corruption and decorruption are deliberate processes and are different from signal degradation due to noise or other environmental effects.

In yet a further embodiment of the present invention a majority of the symbols in a sequence of symbols is modified or corrupted. In yet a further embodiment of the present invention a minority of the symbols in a sequence of symbols is modified or corrupted. A sequence of symbols in the directly above description forms a recognizable composition, such as an image, a frame in a video, a sentence in a paragraph, a segment of an audio file, etc.

Preferably, the sequence is part of or constitutes a file such as an audio-file, a picture file, an image file, an audio-visual file or any file that can be received and displayed as an audio signal for instance through a loudspeaker or as a visual signal displayed on a display or an audio-visual file. The file may also be a data file, such as a financial file, or any other data file.

A sequence of n-state symbols is illustrated in FIG. 14. Herein, n is in one embodiment 2 or greater. Accordingly, in that case a symbol is a binary symbol or a non-binary symbol. In another embodiment n is greater than 2. Accordingly, in that case a symbol is a non-binary symbol. One is reminded that a non-binary symbol can be formed by a plurality of lower radix symbols. For instance an 8-state symbol can be represented by 3 binary symbols or by 2 5-state symbols. FIG. 14 illustrates a sequence 1400 [s₁, s₂, . . . , sₖ, sₖ₊₁, . . . , s_{end}]. Herein, each rectangle sᵢ represents an n-state symbol. The n-state symbols are ordered in a position relative to each other. Thus, the n-state symbols can be represented as a serial sequence of n-state symbols.

In one embodiment of the present invention, the relative position of n-state symbols in a sequence is only presented for illustrative purposes as a serial sequence, and represents for instance an order of processing of the n-state symbols. For instance s₁ is processed first and s_{end} is processed last by a processor. The n-state symbols may be transmitted and stored in a different order, if that is convenient. However, the processing takes place in a specific order, for instance as indicated in FIG. 14.

For specified or unspecified reasons it is desirable to modify part of the sequence in a reversible way. However, modification or corruption in an irreversible way is also provided herein in accordance with an aspect of the present invention. As a result, when the content represented by the sequence, which may be digital audio, video, audio-visual, text or otherwise usable or playable data, can only partly be displayed, listened to or correctly viewed or used. This may be applied for encryption purposes. The partial corruption may also be applied to provide a potential user or buyer a “taste” of the content of the data captured by the uncorrupted sequence.

In general, files like video files can be quite large and to modify only parts of a video frame, so that the modification is reversible, preferably with a random-like appearance and still leaves an intelligible image to evaluate is not simple. If the modification is to be reversible, one would preferably reverse the corruption in real-time, as the signal is being played. Real-time is intended to be interpreted by one of ordinary skill as being within the confines or limitations of the known Nyquist sampling theorem. That means that in real-time a first sample of a signal is being processed completely before the processing of the next sample is due while the processed samples provide a seemingly uninterrupted display.

In some cases real-time processing may not be required. For instance a file or part of a file is processed in its entirety before it is displayed.

FIG. 14 illustrates a sequence of symbols 1400. For illustrative purposes symbols s₃, sₖ₊₂ and sₖ₊₄ are to be modified, either in a reversible way or in a non-reversible way. One of ordinary skill would realize that most “useful” sequences of symbols, be it binary or non-binary, contain, what one may call, housekeeping symbols, or a structure that maintains a certain way of display. In that regard, one can recognize “content” symbols and “housekeeping” symbols in a sequence of symbols. In accordance with one embodiment of the invention, corruption of data is performed on the content symbols of a sequence and not on the housekeeping symbols. Housekeeping symbols are symbols that determine, for instance an end-of-file, an end of a frame line, synchronization symbols, identification symbols and the like. Corruption of these symbols may render a sequence unplayable in its entirety which may not the purpose in at least one embodiment of the present invention.

In one embodiment of the present invention, a symbol is corrupted in a sequence which is structured into codewords of multiple symbols. As described above a method to correct these intentional corrupted is provided to a receiving processor separate from the sequence.

FIG. 15 illustrates how a sequence of symbols can be intentionally corrupted by applying a corruption mask. An actual sequence of symbols, which may be binary symbols or non-binary symbols, contains at least content symbols. The sequence of symbols may also contain housekeeping symbols, which preferably should not be corrupted or modified. In one embodiment of the present invention, content symbols are part of a codeword with error check symbols, which are then considered in this embodiment to be part of the housekeeping symbols.

In accordance with an aspect of the present invention, housekeeping symbols are located in a received sequence of symbols on predetermined locations in the sequence of symbols. A receiver is informed of the format of the sequence of symbols, either from a standard format or in a message that defines the format. Such a message may be, for instance, a header of the sequence of symbols. Based on the knowledge of the structure of the sequence of symbols, the receiver may consider in one embodiment of the present invention, only the content symbols. This is illustrated in FIG. 15, wherein an actual sequence of symbols 1500, containing content symbols as well as housekeeping symbols, is shown. The content symbols of the sequence of symbols are modified (or restored) in accordance with a corruption mask 1502. A processor matches the corruption mask 1502 with the content symbols in the actual sequence of symbols by tracking where the housekeeping symbols are located. In one embodiment of the present invention, progress in the corruption mask is stopped when housekeeping symbols are detected. The moment the symbols are determined to be content symbols the corruption mask 1502 is again applied.

A corruption mask, in one embodiment of the present invention is a sequence of symbols, wherein a specific state of a symbol indicates where a corruption in sequence 1500 should take place or has taken place. In one embodiment the two sequences 1500 and 1502, except for patches with housekeeping symbols, run synchronously, for instance by applying the same clock signal. It may be that a symbol in 1500 is an n-state symbol, for instance represented by a plurality of lower radix symbols, such as bits. For instance assume that the content symbols in 1500 are 256-state symbols represented by a byte of 8 bits. In that case the clock or the derived clock of 1502 should be ⅛ of the clock of 1500. Synchronization symbols may be applied.

It may be that the sequence of symbols has an asynchronous format that applies some synchronization or header to identify the start of housekeeping symbols. Such synchronization symbols will also stop the progress of the corruption mask.

A transmission signal, in one embodiment of the present invention, has additional housekeeping symbols or signals, making synchronization with a sequence that is a corruption mask more complicated. In one embodiment of the present invention, a sequence of symbols is corrupted as soon as possible after it is created, for instance directly after capturing a digital video and/or audio signal or data signals and before certain housekeeping symbols are added to the sequence of symbols. For instance, before error correction codewords are created.

Steps of the process of applying a corruption mask are illustrated in FIG. 16. In step 1601 a structure of a sequence of symbols, especially the housekeeping symbols, is determined and the position of modifiable symbols is determined. In step 1603 a corruption mask is generated or retrieved from memory. In step 1605 the start of the corruption mask and the start of the modifiable symbols in the sequence of symbols are aligned. In step 1607 the modifiable symbols are modified, either corrupted, left unmodified or reversed in corruption, in accordance with the corruption mask. Not shown, but assumed, is that clock signals for progressing the corruption mask and the sequence of symbols are aligned or correctly maintained. Known systems such as PLL clock recovery systems, which are known to one of ordinary skill, can be applied for that purpose.

As indicated above, as corruption mask is a sequence of symbols, in which a specific symbol indicates a position of a symbol in the corresponding sequence of symbols to be corrupted. Because the purpose is not to corrupt all symbols in the sequence of symbols, the corruption mask should be a sequence with at least one type of symbol that does not occur for more than 60%. For instance, one may apply a sequence of binary symbols, with 0s and 1s for instance, in which a 1 indicates that a corresponding symbol in the sequence of symbols should be modified or has been modified and should be reversed. This raises the question of how many symbols in a sequence of symbols can be corrupted without making review of the content too hard to be useless.

There is existing research that indicates at which error ratios, errors become unacceptable. This level appears to be well below a 50% symbol error ration, wherein errors at a lower rate are considered to be annoying in audio than in video. Also a distinction is made between (pseudo-) random errors and burst errors. A burst error may make one or more frames completely unplayable. Such an error burst requires a mask sequence to be completely or mostly completely be of 1s in case of a binary mask. It is of course possible to create and store and then retrieve such a binary corruption mask that has intermittently a series of single identical symbols. However, such a system of burst errors, while provided in accordance with an aspect of the present invention would almost certainly diminish enjoyment of a video or an audio program.

There is, for recovery, another issue that plays a role. One would preferable generate in an automatic way a corruption mask, or provide instructions thereto, rather than sending the complete mask.

In one embodiment of the present invention, especially when recovery is not required, one can create a corruption mask from a sequence of binary symbols, wherein, with exception for periods with all the same symbols (all 1s for instance) to create an error burst, the occurrence of one type of symbols (for instance 1s) is in a pseudo random manner. One may also create a mask that propagates errors. This is illustrated in FIG. 17 which shows an image 1700, for instance a video frame in a series of frames. The frame displays 3 shapes wherein only one shape 1703 is identified with a numeral. Also provided are a plurality of corruption patches inside the frame 1700 of which only 1701 is identified. The patches cover the image, allowing a review but obscuring details. The error rate in this situation is about 15%. When a first corruption location is determined, then the error mask is automatically extended for a predetermined number of symbols. For instance, assume an image line of 32 pixels and a corruption mask for that line of 32 bits. The mask being maskₗᵢₙₑ=[00000101000101100001000010010011]. Assume that a 1 indicates a modified symbol in the sequence of symbols, a symbol in this case being a pixel. A processor modifies the mask as follows: if a 1 is encountered in a mask then the next 2 symbols are also made 1. This is done up to the end of the maskₗᵢₙₑ. Modification does not go beyond a line.

This generates mask_{linemod}=[00000111000111111001110011111111].

The maskₗᵢₙₑ is copied for, for instance k lines, over generated line masks even if other line masks were generated and then the next generated maskₗᵢₙₑ is modified as above. This will generate the patches as shown in FIG. 17. One may repeat the corruption pattern of a frame for about 1 to 5 seconds of video following frames or longer if desired. After that a new set of patches is generated based on a generating pattern. If a corruption pattern is to be reverted the corruptions should not propagate beyond a line and beyond a frame.

It is again noted that corruption patterns as in FIG. 17 can easily be stored in a memory and retrieved to be executed, but are required to follow a set of repeatable rules if one wants to revert the corrupted symbols.

It is also required to determine the corrupted symbol, which in an image frame or video frame may be a pixel determined by 24 bits. One way to modify a pixel is to give it a fixed value like all 1s or all 0s or any other fixed value. However, that prevents the corrupted pixel from being reversible. One way of dealing with that is to reverse by way of corruption one or a number of bits defining the pixels, by making 0 a 1 and by making a 1 a 0. This can be easily reversed. Another way to modify a 24-bit pixel is to XOR the bits with a pre-determined word of 24 bits. One can change the predetermined word for instance in a series of 30 words that repeats. It is fairly easy to share these words and a corruption rule with a receiver.

It is not easy to create a binary generator that generates a sequence of bits with a skewed probability of 1s of about 10%, 20% or even 30%. Known pseudo-random generators create sequences of 1s and 0s with a probability of about 50%. So, for automatic corruption mask generators this will not work for a corruption error rate that is lower than 50%.

In accordance with an aspect of the present invention a shift register based n-state generator is used to create a corruption mask. The inventor has shown is U.S. patent application Ser. No. 13/831,394 filed on Mar. 14, 2013, which is incorporated herein by reference, and elsewhere, how a sequence of n-state symbols with n>2 and n>3 can be generated by an n-state shift register with feedback. The n-state sequence has a distribution of n-state symbols that is perfectly are almost perfectly uniform, with almost equal occurrence of each of the n-state symbols in a generated sequence. This means that in a generated 8-state sequence, which generates for instance symbols 0, 1, 2, 3, 4, 5, 6 and 7 that each of these symbols occurs in about ⅛ of the symbols in the sequence. In that case each symbol, for instance a symbol 5, determines an error position for 12.5% of the symbols. Two symbols, like 5 and 7 in a sequence, determine then a corruption rate of 25% and so on.

Assume part of an 8-state sequence being generated of 32 symbols to be: maskₗᵢₙₑ=[00516713021346572715423067311750]. As an example rule, each symbol 5 is extended for 3 symbols, but does not extend the line. This will create maskₗᵢₙₑ=[00555713021346555715553067311755]. Herein the symbol 5 creates or causes a modification in a corresponding sequence of symbols, for instance in a sequence of pixels. For clarification one may substitute all symbols not 5 with 0 thus providing the mask: maskₗᵢₙₑ=[00555000000000555005550000000055]. One may repeat this line mask for several lines in order to make patches. However, it should be clear that this is not required and that one may generate new mask lines per line, based on the generated sequence.

In one embodiment of the present invention one generates an n-state sequence as a corruption mask and selects one or more symbols that will cause a corresponding symbol in a corresponding sequence of symbols to be corrupted or modified.

As explained above, one can modify or corrupt a symbol permanently in a sequence of symbols by giving it a predetermined value. One may also modify it reversibly by inverting it or by modifying it against a known symbol, which may be an n-state symbol with n>1 or with n>2 or n>3. In accordance with an aspect of the present invention, one may apply an n-state logic function to modify a symbol in the sequence of symbols. This requires a second symbol to modify it against. One may also apply an n-state inverter, which may be an n-state reversible inverter or an n-state non-reversible inverter.

In general, an n-state symbol is something like a 256-state symbol, such as a text symbol. Modification of such a symbol by a 256-state switching function or a 256-state inverter is well within the capabilities of processors as at least some of these operations are defined by a finite field GF(256) as used for instance in finite field arithmetic. However, DVD quality image and audio samples can be 16 bits, 24 bits or even higher quality samples. Pixels may be represented in 24-bits, 30 or 32 bits or even higher. In one embodiment of the present invention the entire representation of a pixel is modified. For instance a 24-bit word is added (with OR functions) to the pixel representation of 24 bits. This can be reversed by adding with XOR the same modifying word. One also can take for instance 8 bits in a pixel representation and modify this part of the signal representation with either an 8-bits word or by applying a 256-state switching function or a 256-state inverter.

While pixels are used as illustrative examples, a symbol may of course also represent a sound signal, text, or any other data.

FIG. 19 shows a gray coded image of 75 by 100 pixels. Each pixel is being coded in one of 8 gray levels. A screenshot of the Matlab program that normalizes a 256 level gray image to an 8-level gray image is provided in FIG. 20. The normalization is done to simplify the illustrative procedure. One may also use a 256-level gray level image and use an appropriate 256-level modification function (reversible or irreversible) to modify the pixel. As stated above, one may also modify part of a symbol, by splitting up a symbol, such as a 24-bits pixel, in for instance two or more binary representations, such as 3 8-bit words. One may then modify one or more of the 8-bits parts with a 256-level function.

The problem of corrupting a sequence of symbols can be analyzed in two steps: (1) to generate a corruption mask and (2) to apply the mask to modify the sequence.

In accordance with an aspect of the present invention, the generation of the corruption mask and the modification or corruption of the sequence takes place in real-time, within preferably the constraints of the well known sampling theorem and decorruption preferably also takes place in real-time, within the same constraints and as a sequence of symbols is being received. The latter embodiment, of course, requires that a sequence of symbols is received at a rate that not slower than dictated by the real-time constraints, as is known to one of ordinary skill.

In a further embodiment, the corruption and/or the decorruption takes place not in real-time. In a further embodiment of the present invention the corruption mask is transmitted to a receiver, preferably separate from the corrupted sequence of symbols, either through a separate transmission channel or via a different medium or at a different time than the sequence of corrupted symbols.

In yet a further embodiment of the present invention no corruption mask is transmitted to a receiver, but information or data how to generate a mask is provided to the receiver, allowing the receiver to implement a procedure to generate the corruption mask in real-time and synchronized with the corrupted sequence of symbols to decorrupt the corrupted sequence of symbols.

An illustrative example of a corruption mask for a 75 by 100 pixels image frame, which may be part of a video stream is shown in FIG. 21. The “blocked” or corrupted parts of the sequence of symbols (placed in an image frame in this case) are black, while the white parts are uncorrupted pieces of the sequence. A screenshot of a Matlab program that generates a mask is provided in FIG. 22A, FIG. 22B and FIG. 22C. The preference in this case is to generate a random appearing mask, which provides an annoyance level that is more difficult to achieve with a regular pattern such as horizontal or vertical bars or any other pre-set mask. However, other masks are fully contemplated and are included herein. Preferably such masks are generated automatically by instructions in a program.

In accordance with an aspect of the present invention, a corruption mask is generated by generating and applying a sequence of symbols, wherein certain symbols are designated to determine the corrupting spot in the sequence of symbols. The program as displayed in FIGS. 22A, 22B and 22C generates a sequence of 8-state symbols. This sequence generator is an 8-state Maximum Length sequence generator of 4095 8-state symbols. Because the image has 7500 pixels, the sequence is extended to 7500 pixels. The 8-state symbol represented by ‘6’ is selected as determining a corrupting location. Because the corrupting 8-state sequence is ML each 8-state symbol appears exactly or about ⅛ of the total number of symbols. In order to extend the corruption each occurring corrupting location (corresponding to ‘6’) is extended with 2 positions for 2 rows. One may also apply other extension methods, such as using other symbols (for instance ‘3’) also as a corruption location. It should be clear that the herein provided methods allow to generate a corruption mask that appears to be random has a corruption rate that can be preset.

For instance if one prefers to have a lower corruption rate, no extensions may be applied. One may also apply a higher level of n-state symbols like a 32-state ML sequence, wherein each 32-state symbols provides a corruption rate of about 3-4% ( 1/32). If one prefers to not have repetitive masks, one may apply shift registers with more shift register elements. For instance one may create a very long sequence (a pseudo infinite length non-repetitive sequence) by using for instance a 10-element 32-state shift register. The higher the value of n (like 256), the shorter the shift register can be.

Presently a video frame may have pixel lines of at least 1000 color pixels and at least 1000 lines. For about 4 corruption positions on a pixel line of 1000 pixel then a 256-state ML would probably be sufficient. However, different approaches are possible to generate automatically a corruption mask. The instructions for generating a corruption mask depend on the desired corruption rate, the size of the frame or the sequence of symbols and a requirement for repetitiveness.

One may also modify an 8-state sequence, which may be an ML sequence, for long lines of pixels. On average each 8-step ML sequence has 1 of 8 different states in 8 consecutive symbols. If one wants to create about 4 corruption locations on a line of 1000 pixels for instance by occurrence of a symbol ‘5’, an 8-state ML sequence can be applied in the following way: (a) generate the ML sequence and at the first occurrence of symbol 5, mark the start of a part of a corruption mask. Extend the count of the mask with a desired number of pixel positions. The advancement of generating the ML sequence may be stopped during the extension. After the extension, continue the ML sequence. One rule may be that each symbol in the ML sequence is applied to about 30 positions of a pixel line, wherein the symbol 5 provides 30 corruption positions and any other symbol provides uncorrupted positions. Accordingly, 33 8-state symbols cover about 1000 (≈33*30) pixels. The rule stops at the end of the pixel line (k=1000). The same rule may be applied for, for instance, the next 30 lines (for instance by saving and repeating the specific line mask), after which the ML sequence is further advanced to create a new mask.

One may of course also continue to run the ML sequence and continue generating the mask. The mask will repeat after a full length of the ML sequence has been generated.

It should be apparent to one of ordinary skill that any repeatable rule may be applied. For instance, advancement of the mask relative to pixels may depend on the symbol. (for instance advance 20 positions at symbol 1 and 40 positions at symbol 7). In case of a frame dependent mask (such as in images) one may apply the restrictions of the frame. However, it should be clear that one may also apply a mask to a sequence, rather than to a frame, as long as one takes into account and excludes the housekeeping symbols from masking

In accordance with an aspect of the present invention, a mask is generated based on a corruption rate, which may be expressed as a relative rate, of symbols being corrupted relative to the total number of symbols in the sequence. In accordance with an aspect of the present invention, the relative corruption rate is not greater than 0.1%. In accordance with a further aspect of the present invention, the relative corruption rate is greater than 0.1% but not greater than 1%. In accordance with yet a further aspect of the present invention, the relative corruption rate is greater than 1% but not greater than 5%. In accordance with yet a further aspect of the present invention, the relative corruption rate is greater than 5% but not greater than 10%. In accordance with yet a further aspect of the present invention, the relative corruption rate is greater than 10% but not greater than 25%. In accordance with yet a further aspect of the present invention, the relative corruption rate is greater than 25% but not greater than 50%. In accordance with yet a further aspect of the present invention, the relative corruption rate is greater than 50%.

From the above description, one of ordinary skill will understand that one can design a corruption mask that meets desired corruption rate requirements.

It should also be clear that one can create a corruption mask with at least 2 consecutive symbols to be corrupted. In a further embodiment of the present invention, a corruption mask is created that corrupts at least 5 consecutive symbols. In a further embodiment of the present invention, a corruption mask is created that corrupts at least 20 consecutive symbols. In accordance with an aspect of the present invention a corruption mask is provided that provides a corruption pattern that provides a random or a pseudo-random corruption pattern. FIG. 25 provides a pseudo-random corruption mask for a 75 by 100 pixel image. FIG. 26 provides a corrupted 75 by 100 grayscale pixel image that is corrupted in a reversible manner in accordance with the mask of FIG. 25. FIG. 23 shows the reversibly corrupted image corrupted in accordance with the corruption mask of FIG. 21.

It is again emphasized that in accordance with an aspect of the present invention, also more regular corruption masks are provided, for instance using bars, or patches or figures or any corruption pattern that can be generated or stored and provided at desired moments.

In accordance with an aspect of the present invention, the corruption is irreversible. That means that corruption takes place with an irreversible function. One may replace the symbols in the sequence corresponding to the corruption mask with a single value (like a corresponding black value) or apply an irreversible switching function or inverter.

In accordance with a further aspect of the present invention, the corruption is a reversible process and the sequence can be decorrupted or restored to its original form. This is made possible to apply a reversible corruption function. For instance, an addition is used, wherein in the case wherein symbols are 256 gray levels a known 256-state symbol is added to an 256-state symbols that needs to be corrupted. If needed one may represent such an addition (or any other reversible n-state function) in binary form. One may add the same 256-state symbols or use a set of 256-state symbols that are selected based on a rule. Different reversible n-state functions are available. If one prefers to use n-state symbols, wherein n>256, it may be easier to add binary words. However, using a single reversible function (the addition) may offer opportunities to determine the corruption rule.

In case of a 2-input n-state logic function one may provide a known symbol on an input to modify the symbol on the second input. The known symbol may be selected from a list of known symbols, for instance stored on a memory. A processor may also keep track of corrupted and uncorrupted symbols and may use a previously corrupted or uncorrupted symbol in the sequence as the “known” symbol. One may also change the applied logic functions, or change inverters at an input or output of an 2-input n-state logic function.

Preferably, the corruption rules are difficult to determine. In that case it is preferred to apply different corruption n-state functions. If one wants to limit the storage of large n-state truth tables, one may apply a limited number of reversible n-state inverters. For instance a 1024-state 2-input/1 output switching function is represented by a 1024 by 1024 truth table. One may also selected a limited number (say 100, or more or fewer) 1024-state reversible inverters that are selected to corrupt a sequence of symbols. This provides sufficient variation without being easy to reconstruct without knowing the rules.

In one embodiment of the present invention one applies irreversible corruption functions that look at first sight as being reversible, but are in fact not. For instance one may apply a 1024-state irreversible inverter that has about 900 of its 1024 states reversible but has 124 duplicate states.

In many cases it is simpler to use n-state inverters for corruption (reversible or irreversible) which are one dimensional, rather than 2-dimensional truth tables. For instance a 24-bit pixel can be split up in 3 8-bit bytes. Each byte (which is 256-state) may be modified with for instance one of for instance 63 256-state inverters. The selection of each inverter may be done automatically, for instance based on a content of a shift register of an 8-state LFSR that is running as symbols are being processed. One may run 3 different LFSRs with different periods to determine the 3 contents, each content determining one of a set of different 56-state inverters. Each inverter determining an inversion of a byte in the 24-bit symbol. Preferably each inverter is reversible, so that for decorruption the same LFSRs can be applied, but now assigned to the reversing inverters.

Simple 8-state corruption examples are provides that allow to easily follow the corruption process and making clear that higher state and more complex corruption schemes are possible.

FIG. 22A, lines 1-40 illustrate in the screen shot of this Matlab program the generation of a 75*100=7500 8-state symbol sequence. The starting 8-state shift register state is [3 5 8 6] (in origin 1). The sequence is ML of length 8⁴−1=4095 and thus repeats itself at 4096. Different inverters can be applied to generate an ML sequence and the starting position of the shift register can be changed to generate a different sequence. Sequence generators of other lengths and other values of n can be generated also. In lines 43-45 the sequence is modified to corrupt for symbol 6. In lines 47-53 the corruption sequence is placed into a 75 by 100 frame format. In lines 59-91 the corruption locations on a line are extended with 2 and a corruption line is extended to 2 following lines, to create the mask of FIG. 21, taking into account the length of a line (100 pixels) and the number of lines in a frame (75). For display purposes the corruption spots are provided with the gray value 0 (black).

For illustrative purposes the generating functions are an addition and a multiplication over GF(8). However, this is not required. Other functions, even non-commutative functions and functions wherein F(0,0) (in origin 0) is not 0.

The screenshot of FIG. 24 shows the reversible corruption. The image that needs to be corrupted is first normalized to 8 gray levels, as shown in FIG. 20. The 8-state normalized image is then corrupted by corrupting all gray pixels corresponding to the black positions in the corruption masks with the 8-state inverter [1 2 3 4 5 6 7 8]→[5 6 7 8 1 2 3 4] which is a self reversing 8-state inverter. By applying this inverter again, the corruption is reversed. Lines 15 and 19 restore the normalized 8-state representation to a 256-state gray level.

FIG. 28 shows a corruption mask that does not apply extensions. FIG. 26 shows the image reversibly corrupted by the mask of FIG. 26 and FIG. 27 shows the decorrupted image recovered by applying the corruption mask and the corruption inverter again, and shows a perfectly recovered image. The apparent flaws in FIG. 27 are original and were caused by the normalization prior to corruption and are for instance visible in FIG. 19.

In accordance with an aspect of the present invention corruption and decorruption may be stopped and started again. In that case one may apply known sequence synchronization methods for an n-state sequence generator, for instance by saving the shift register state when the generation is stopped and using that state for restarting the process. One may also transmit synchronization information, for instance as shift register synchronization symbols, as provided for instance in U.S. patent application Ser. No. 13/118,767 filed on May 31, 2011 which is incorporated herein by reference in its entirety. One may also send sync information related to a start or an end of a frame, such as an image frame, or a document page or a segment of an audio recording.

The methods and apparatus as provided above thus provide for real-time decorrupting by a receiver by generating synchronized with a received corrupted sequence a corresponding corruption mask and decorrupt the corrupted symbols. In accordance with various aspects of the present invention, a corrupted file from a source to a receiver is provided and at least one method to decorrupt the corrupted file, preferably in real-time, but also not in real-time, at the receiver is also provided.

This is illustrated in FIG. 28 with a network 2800, which may be the Internet, a source 2802 connected wired or wirelessly via the network 2800 to at least a target 2804 which is also connected to the network 2800. The source 2802 provides a corrupted file to target 2804 for playing. After playing and review of the corrupted file, a user of the target decides that a decorrupted file is desired. The decorruption method can be obtained from source 2802 or from a server 2806 also connected to network 2800. For instance decorruption is obtained by paying a fee. In a further embodiment of the present invention source 2802 provides a corrupted or a clean file to 2806 which is stored. Via a menu, target 2804 may view a corrupted file and decides to obtain a decorrupted file from 2806, for instance via payment. Server 2806 may first send a decorruption method, comprising a mask or a rule for a mask and a decorruption rule to target 2804 and then streams the corrupted sequence to 2804 which has the decorruption rule installed on a memory/processor unit. In a further embodiment 2806 provides a free streaming service, which contains at least corrupted files. In one embodiment of the present invention only part of the file is corrupted, for instance a start is decorrupted and the corruption rate of a file starts after a certain time and may be increased at later stages of the sequence.

In order for 2804 to play a decorrupted file a decorruption method can be obtained, for instance after payment, from either 2806 or from 2802. A decorruption method requires a much smaller file and transmission than the corrupted file. For instance a file may be a video file with 100s of millions or billions of symbols. The decorruption method may require a file that is not even 1 Meg in size. Decorruption, thus requires much smaller storage and transmission capabilities. An administrator only has to track the decorruption method corresponding to a defined corrupted file.

A streaming service may provide a video program that has corruption, for instance at certain periods, even 100% corruption. By purchasing and downloading and installing a decorruption program on a processor a target can view a completely decorrupted program, wherein the decorruption program synchronized with the received corrupted file generates a decorrupted file.

One purpose of corruption of a file is to enable playing of a file, but only in a partial way. In accordance with another aspect of the present invention a line coded or even a compressed file is corrupted in accordance with reversible or irreversible methods as provided herein, and is decorrupted by a receiver.

A corruption mask as provided herein combined with the n-state corruption method can also be applied to create a fingerprint of a sequence, such as an image or a video frame. Rather than actually corrupting the sequence, one only generates the corruption mask and the corrupted symbols, but the symbols in the sequence remain uncorrupted. One can keep the corrupted symbols as a fingerprint of a frame. One may apply the corrupted symbols or the symbols corresponding to the corruption mask into an n-state shift register based scrambler. The end state of the shift register is a hash for a frame. One may also determine a hash for a plurality of masked frames. A plurality of hashes, for instance of a number of overlapping frames, for instance of frames 1-25, frames 2-26, frames 3-27. A number of running hash values is generated by a masked signal by applying non-binary shift register based methods thus forming a dynamic fingerprint. By using the methods provided herein, the dynamic range of the fingerprints is expanded. For instance if one changes the corruption functions, for instance by using different non-binary inverters, over a frame or between frames, then even homogeneous colored frames will provide different hash functions. Fingerprinting of multi-media such as video by hash functions is known. It is for instance described in U.S. Pat. No. 5,606,609 issued to Houser on Feb. 25, 1997 and U.S. Pat. No. 7,240,210 issued to Mihcak on Jul. 3, 2007, which are incorporated herein by reference. Using the mask generating methods and modifying methods which may be reversible, as disclosed herein are believed to be novel.

N-valued symbols are also called n-state symbols herein, meaning the same. When using the term n-state or n-valued or multi-valued herein, in general non-binary or n>2 is intended, wherein n is an integer, unless indicated otherwise. Also the term logic function or switching function is used herein, meaning the same. A logic function has a symbolic representation for instance by a truth table. The logic function describes a physical device that processes signals in accordance with the logic function, a symbol in general being represented by one or more signals. A logic function herein is represented by a truth table. A logic function can be a two input/single output logic function. This may also be called a dyadic function, a two-place function or a 2-argument function. An n-state addition, such as a modulo-8 addition is a dyadic function or a two argument function. Two arguments are processed in accordance with a mod-8 addition truth table to generate a modulo-8 addition residue. The truth table of an n-state dyadic function is in general represented by an n by n matrix. Multi-argument logic functions. with more than 2 arguments are also possible.

N-state or n-valued inverters are also disclosed herein. An n-state inverter is a monadic or single argument logic function. It has a single input and a single output. Its representation is in general a 1-dimensional vector describing the output states for each of the possible (n) input states. In general, logic functions as known, such as the mod-n addition or addition over GF(n) show that inputs 0 and 0 provide an output 0. Such a requirement does not apply here, unless specifically required. Also state 0 is not required to be inverted by an n-state inverter to a state 0, unless specifically required.

The methods and apparatuses provided herein apply a processor based system as displayed in FIG. 29. The system contains a memory 2902 which contains instructions that can be retrieved by the processor 2901 to perform steps that implement the methods as disclosed herein. Memory 2903 contains data that can be applied to be processed by the processor based on instructions. Memory 2903 can also store data such as intermediate results. Memory 2904 is a mass storage medium, which can be electronic storage media, optical or magnetic storage media or any other medium that is enabled to store and provide massive amounts of data, for instance representing video data, audio data, graphics data, hexadecimal data, symbol data and the like. An input device 2905 such as a keyboard or a mouse can be used to control the processor or can be an input device such as a camera or a microphone. The processor can connect to a network via an input/output 2906 to a network device to send and to receive data. Data, images and menus can be displayed on an output device 2907, which may be a display screen, a printer, a loudspeaker or any other output device. Computing devices 2802, 2804 and 2806 are programmable processor controlled devices. These may be mobile wireless devices or wired devices.

The sequence of n-state symbols, which means a sequence or stream of non-binary symbols, is a digital medium or media stream. This means that the sequence of n-state symbols represents data that can be played or displayed on an appropriate medium, such as a display screen, an audio signal player, such as a loudspeaker, a print medium such as paper. Examples of n-state or non-binary symbols are pixels either in black or white or gray scale, for instance in a 256 level gray scale or full color pixels for instance in 24-bit or 32 bit coded pixels. Pixels may include an alpha channel code which determines a transparency of a pixel. Corruption of the n-state pixels may be a modification of a transparency in one embodiment of the present invention. Pixels may be part of a single frame image or a still image or may be part of a digital video stream with multiple frames. N-state or non-binary symbols may also be a representation of a digital audio signal. For instance a non-binary symbol may be a sample of an audio signal that is digitally coded. An n-state or non-binary symbol may also be a character in a digital file or document.

An n-state or non-binary symbol may be represented as a word of bits or a binary word. For instance characters in a digital document are often coded as a byte of 8 bits. In one embodiment of the present invention a corruption mask that covers at least a length of one n-state symbol binary word may be synchronized with beginning and ending of a binary word representing the n-state symbol and in another embodiment of the present invention it is not synchronized with the symbol words, and thus may corrupt two adjacent n-state symbols.

A corruption mask may be a regular mask that will be the same for several consecutive frames for instance in a video stream. In that case the mask will not jump with each frame. If frame and mask sequence are not synchronized for at least several frames, for instance for at least 10 seconds of frames, the user may find the corruption too annoying to endure, which in some cases may not be what is desired. In another embodiment of the present invention one does not synchronize the mask sequence with a frame and the mask appears to jump constantly, providing a more random experience. This may be desirable in a corruption of an audio stream, wherein a regular corruption may appear as a discernable sound, which may be highly annoying, while random corruption may appear as irregular clicks. In a further embodiment of the present invention a media stream is a combined stream of digital video and audio. In one embodiment of the present invention both streams in the audio-video stream are corrupted in an individual way, wherein for instance each stream has a different mask and/or a different corruption rate and/or a different corruption function. One stream in the audio-visual stream may be corrupted while the other stream is uncorrupted.

N-state functions disclosed herein can be realized by multiple binary functions such as XOR functions. N-state functions, both inverters and two argument functions can be implemented by storing the truth functions in a memory and determining the output state based on relevant input states. An input state may form a relevant address to the intended output state. One may work in binary representation if so desired. One may also work with actual n-state signals by applying A/D and D/A converters to interface with binary memory.

The processing speed of corrupting and decorrupting symbols by a processor is preferably at a speed of at least 1000 n-state symbols per second, preferably at a speed of at least 32,000 n-state symbols per second and most preferably at a speed of at least 1,000,000 n-state symbols per second.

A non-binary or n-state 2-argument logic function in one embodiment of the present invention is an addition over GF(n) either stored as a truth table in a memory or realized with for instance XOR functions. The non-binary or n-state 2-argument logic function in an embodiment of the present invention is not an addition over GF(n) or is an addition over GF(n) wherein addition of state 0 and 0 does not generate 0. The non-binary or n-state 2-argument logic function in an embodiment of the present invention is a non-commutative function. The non-binary or n-state 2-argument logic function in an embodiment of the present invention is a commutative function. A non-binary or n-state 2-argument logic function herein is represented or is equivalent to a single truth table, even if it is realized by applying one or more inverters at an input and/or inputs and/or output. A non-binary or n-state logic function either 1-argument or multi-argument inputs is preferably reversible in one embodiment of the present invention and non-reversible in another embodiment of the present invention.

N-state or non-binary inverters in one embodiment of the present invention, are selected from columns or rows of an n-state logic function. Clearly, each n-state 2-argument truth table has n columns and rows, each column and row representing an n-state inverter. In one embodiment of the present invention n-state inverters are not selected from a single n-state 2-argument logic function. There are n! different n-state reversible inverters. Clearly, the selection in that case is much broader than selecting from a single n-state 2-argument truth table and there is no derivable relationship between many reversible n-state inverters, making it harder to predict which n-state inverter is being used.

A digital medium stream represents at least one medium. It may also be a multi-media stream if it contains for instance two of audio, image such as video and other data. A mask may be generated for all streams concurrently or for each stream individually. Each stream may be coded differently. For instance a video stream may have 24-bit equivalent pixels, audio may be coded in 12-bit equivalent sound sample size and data may be characters coded as 8-bit bytes. This may require different corrupting n-valued logic functions, appropriate for the corrupting task at hand (for instance an n1-state logic function for video, an n2-state logic function for audio and an n3-state logic function for other data, wherein n1, n2 and n3 are different integers).

It should also be clear that a mask may be created with an entirely different nonbinary sequence, wherein the number of states in the mask generating sequence is different from the number of states in the modifying functions. The number of states may also be the same, if that is appropriate for the intended use. To emphasize the possible difference in states, it may be expressed that a mask is generated by a k-state sequence generator, generating k-state (non-binary) symbols. The modifying functions are n-state. Thus k and n may be different integers, they may also be identical integers.

A device that receives a corrupted stream of symbols is in one embodiment of the present invention a wireless and portable computing device such as a smartphone, a computing tablet, a digital radio and/or tv receiver, a medium player. It also can be a wired and/or any computing device.

While there have been shown, described and pointed, out fundamental novel features of the invention as applied to preferred embodiments thereof, it will be understood that various omissions and substitutions and changes in the form and details of the devices, systems and methods illustrated and in their operation may be made by those skilled in the art without departing from the spirit of the invention. It is the intention, therefore, to be limited only as indicated by the scope of the claims appended hereto.

The following patent applications, including the specifications, claims and drawings, are hereby incorporated by reference herein, as if they were fully set forth herein: (1) U.S. Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS; (2) U.S. Pat. No. 7,002,490 issued on Feb. 21, 2006, entitled TERNARY AND HIGHER MULTI-VALUE SCRAMBLERS/DESCRAMBLERS; (3) U.S. Non-Provisional patent application Ser. No. 10/912,954, filed Aug. 6, 2004, entitled TERNARY AND HIGHER MULTI-VALUE SCRAMBLERS/DESCRAMBLERS; (4) U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA; (5) U.S. Pat. No. 7,218,144, issued on May 15, 2007, entitled SINGLE AND COMPOSITE BINARY AND MULTI-VALUED LOGIC FUNCTIONS FROM GATES AND INVERTERS; (6) U.S. patent Ser. No. 11/065,836 filed Feb. 25, 2005, entitled GENERATION AND DETECTION OF NON-BINARY DIGITAL SEQUENCES; (7) U.S. Pat. No. 7,397,690 issued on Jul. 8, 2008, entitled MULTI-VALUED DIGITAL INFORMATION RETAINING ELEMENTS AND MEMORY DEVICES; (8) U.S. Non-Provisional patent application Ser. No. 11/618,986, filed Jan. 2, 2007, entitled Ternary and Multi-Value Digital Signal Scramblers, Descramblers and Sequence Generators; (9) United States Non-Provisional patent application Ser. No. 11/679,316 filed Feb. 27, 2007, entitled Methods And Apparatus In Finite Field Polynomial Implementations; (9) U.S. Non-Provisional patent application Ser. No. 11/566,725, filed on Dec. 5, 2006, entitled: Error Correcting Decoding For Convolutional And Recursive Systematic Convolutional Encoded Sequences; (10) U.S. Non-Provisional patent application Ser. No. 11/739,189, filed on Apr. 24, 2007 entitled: Error Correction By Symbol Reconstruction In Binary And Multi-Valued Cyclic Codes; (11) U.S. Non-Provisional patent application Ser. No. 11/969,560 filed Jan. 4, 2008, entitled: Symbol Error Correction by Error Detection and Logic Based Symbol Reconstruction; (12) U.S. Non-Provisional patent application Ser. No. 11/964,507 filed on Dec. 26, 2007 entitled Implementing Logic Functions With Non-Magnitude Based Physical Phenomena, and (13) U.S. Non-Provisional patent application Ser. No. 14/064,089 filed: Oct. 25, 2013 entitled Methods and Apparatus in Alternate Finite Field Based Coders and Decoders.

1. A system to process a digital medium stream containing a plurality of symbols, each symbol being represented by one or more signals, comprising:
a source memory enabled to store and provide data including instructions;
a source processor configured to retrieve and execute instructions from the source memory to perform the steps:
generating a corruption mask determined by a sequence of symbols generated by a sequence generator; and
modifying a plurality of n-state symbols with n>2 in the digital medium stream in accordance with the corruption mask to create a corrupted digital medium stream.

2. The system of claim 1, further comprising:
the source processor executing instructions to apply a first logic function to create a corrupted n-state symbol in the corrupted digital medium stream.

3. The system of claim 2, further comprising:
transmitting the corrupted digital medium stream to a target processor configured to retrieve instructions from a target memory to perform the steps:
generating the corruption mask; and
modifying the corrupted digital medium stream in accordance with the corruption mask by applying a second logic function that reverses the first function to decorrupt the corrupted n-state symbol.

4. The system of claim 1, wherein the sequence generator generates k-state symbols with k>2.

5. The system of claim 4, wherein the sequence generator is a maximum length sequence generator.

6. The system of claim 2, wherein the first logic function is a two argument logic function.

7. The system of claim 2, wherein the first logic function is an inverter, selected by the source processor from a plurality of inverters.

8. The system of claim 1, wherein the digital medium stream represents an image.

7. (canceled)

9. (canceled)

10. The system of claim 3, wherein modifying the corrupted digital medium stream takes place in real time.

11. An apparatus to process a corrupted digital medium stream of symbols, each symbol being represented by one or more signals, comprising:
a memory enabled to store and provide data, including instructions;
a processor configured to retrieve instructions from the memory and to execute the retrieved instructions to perform the steps:
receiving the corrupted digital medium stream which contains a plurality of corrupted n-state symbols with n>2;
generating a corruption mask by applying a sequence of symbols;
identifying the plurality of corrupted n-state symbols by applying the corruption mask; and
decorrupting at least one n-state symbol in the identified plurality of corrupted n-state symbols by applying a logic function.

12. The apparatus of claim 11, wherein the sequence of symbols is generated by a k-state sequence generator with k>2.

13. The apparatus of claim 11, wherein the logic function is a two argument logic function.

14. The apparatus of claim 11, wherein the logic function is an inverter.

15. The apparatus of claim 11, wherein the corrupted digital medium stream represents an image.

16. (canceled)

17. The apparatus of claim 11, wherein decorrupting the corrupted digital medium stream takes place in real time.

18. A method for processing a corrupted digital medium stream of symbols, each symbol being represented by one or more signals, comprising:
receiving by a processor of the corrupted digital medium stream which contains a plurality of corrupted n-state symbols with n>2;
generating by the processor of a corruption mask by applying a sequence of symbols;
identifying by the processor of the plurality of corrupted n-state symbols by applying the corruption mask; and
decorrupting by the processor of at least one n-state symbol in the identified plurality of corrupted n-state symbols by applying a k-state logic function with k equal to or smaller than n.

19. The method of claim 18, wherein the k-state logic function is a k-state inverter, selected by the processor from a plurality of k state inverters.

20. The method of claim 18, wherein the k-state logic function is a two argument logic function.

21. The system of claim 1, wherein at least one n-state symbol in the plurality of n-state symbols in the digital medium stream is represented by a word of bits and the first logic function modifies a subset of bits in the word of bits.

22. The apparatus of claim 11, wherein at least one of the plurality of corrupted n-state symbols is represented by a word of bits in which a subset of bits is corrupted by applying a k-state logic function with k<n and the logic function reverses the k-state logic function.
